(19) United States
(12) Patent Application Publication
(10) Pub. No.: US 2025/0311011 A1
(43) Pub. Date: Oct. 2, 2025

(54) RANDOM ACCESS VALIDATION ACROSS MULTIPLE SYMBOL TYPES

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Abdelrahman Mohamed Ahmed Mohamed IBRAHIM, San Diego, CA (US)

(21) Appl. No.: 19/042,330

(22) Filed: Jan. 31, 2025

Related U.S. Application Data
(60) Provisional application No. 63/572,711, filed on Apr. 1, 2024.

(51) Int. Cl. H04W 74/0833; H04L 5/14; H04W 72/21

(52) U.S. Cl. CPC H04W 74/0833; H04L 5/14; H04W 72/21

(57) ABSTRACT

Methods, systems, and devices for random access validation across multiple symbol types are described. In some examples, a user equipment (UE) may receive a configuration message that indicates to the UE a set of random access channel (RACH) occasions for performance of a random access procedure. In some examples, the UE may select a valid RACH occasion from the set of RACH occasions based on a first validity rule, where the first validity rule defines a validity of a RACH occasion when the RACH occasion is associated with a first slot that spans one or more sub-band full duplex (SBFD) resources and one or more non-SBFD resources. In some examples, the UE may transmit, during the valid RACH occasion selected in accordance with the first validity rule, a physical RACH (PRACH) preamble.

### CROSS REFERENCE

The present application for patent claims the benefit of U.S. Provisional Patent Application No. 63/572,711 by ABDELGHAFFAR et al., entitled “RANDOM ACCESS VALIDATION ACROSS MULTIPLE SYMBOL TYPES”, filed Apr. 1, 2024, which is assigned to the assignee hereof, and is expressly incorporated by reference herein.

### FIELD OF TECHNOLOGY

The following relates to random access validation across multiple symbol types, including random access validation across multiple symbol types.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access validation across multiple symbol types. For example, the described techniques provide for a network entity and a user equipment (UE) to increase the efficiency of preamble transmission. For example, the UE and the network entity may use a validity rule to analyze whether a given random access channel (RACH) occasion (RO) is a valid RO for transmission of a random access preamble.

In some examples, the RO is valid based on the RO spanning exclusively subband full duplex (SBFD) resources of a PRACH slot or spanning exclusively the non-SBFD resources of the physical RACH (PRACH) slot. In some cases, a similar rule may be used for validation of physical uplink shared channel (PUSCH) occasions (POs) for a two-step RO.

In some examples, an RO may be valid when spanning both SBFD and non-SBFD resources if one or more conditions are met. The conditions may include the SBFD and non-SBFD resources being directly adjacent in time (e.g., no time gap), and that the RO is associated with a same set of frequency resources, a same spatial configuration, and a same power control parameter across the SBFD resources and the non-SBFD resources. In some cases, a similar rule may be used for validation of POs for a two-step RO.

In some examples, an RO may be valid when spanning both SBFD and non-SBFD resources when there is a guard period (e.g., time gap) between the SBFD and non-SBFD resources. In a first example, the UE may ignore the guard period and transmit the RACH preamble during the entire RO. In a second example, the UE may drop the portion of the RACH preamble during the guard period but transmit the portions of the RACH preamble during the SBFD and non-SBFD resources. In a third example, the UE may drop the portion of the RACH preamble during non-SBFD resources and transmit exclusively during the SBFD resources. In a fourth example, the UE may drop the portion of the RACH preamble during SBFD resources and transmit exclusively during the non-SBFD resources. In some cases, a one or more similar rules may be used for validation of POs for a two-step RO.

In some examples, an RO may include a set of sequence repetitions of PRACH preamble, where the UE may transmit the RACH preamble during each sequence repetition. As such, an RO may be valid when spanning both SBFD and non-SBFD resources if one of the sequence repetitions of the RO aligns with a boundary between the SBFD and non-SBFD resources.

Additionally, or alternatively, the UE may be configured with a second RO that is time division duplex (TDD) RO scheduled exclusively for non-SBFD resources. As such, an RO may be valid based on how the RO overlaps with the second RO across time and frequency.

A method for wireless communications by a UE is described. The method may include receiving a configuration message that indicates to the UE a set of multiple ROs for performance of a random access procedure, selecting a valid RO from the set of multiple ROs based on a first validity rule, where the first validity rule defines a validity of a RO when the RO is associated with a first slot that spans one or more SBFD resources and one or more non-SBFD resources, and transmitting, during the valid RO selected in accordance with the first validity rule, a PRACH preamble.

A UE for wireless communications is described. The UE may include one or more memories storing processor executable code, and one or more processors coupled with the one or more memories. The one or more processors may individually or collectively be operable to execute the code to cause the UE to receive a configuration message that indicates to the UE a set of multiple ROs for performance of a random access procedure, select a valid RO from the set of multiple ROs based on a first validity rule, where the first validity rule defines a validity of a RO when the RO is associated with a first slot that spans one or more SBFD resources and one or more non-SBFD resources, and transmit, during the valid RO selected in accordance with the first validity rule, a PRACH preamble.

Another UE for wireless communications is described. The UE may include means for receiving a configuration message that indicates to the UE a set of multiple ROs for performance of a random access procedure, means for selecting a valid RO from the set of multiple ROs based on a first validity rule, where the first validity rule defines a validity of a RO when the RO is associated with a first slot that spans one or more SBFD resources and one or more non-SBFD resources, and means for transmitting, during the valid RO selected in accordance with the first validity rule, a PRACH preamble.

A non-transitory computer-readable medium storing code for wireless communications is described. The code may include instructions executable by one or more processors to receive a configuration message that indicates to the UE a set of multiple ROs for performance of a random access procedure, select a valid RO from the set of multiple ROs based on a first validity rule, where the first validity rule defines a validity of a RO when the RO is associated with a first slot that spans one or more SBFD resources and one or more non-SBFD resources, and transmit, during the valid RO selected in accordance with the first validity rule, a PRACH preamble.

In some examples of the method, UEs, and non-transitory computer-readable medium described herein, the valid RO may be valid based on the valid RO spanning exclusively the one or more SBFD resources of the first slot or spanning exclusively the one or more non-SBFD resources of the first slot, in accordance with the first validity rule.

In some examples of the method, UEs, and non-transitory computer-readable medium described herein, the valid RO may be valid based on the valid RO spanning the one or more SBFD resources and the one or more non-SBFD resources, the one or more SBFD resources and the one or more non-SBFD resources may be directly adjacent in time, and the valid RO may be associated with a same set of multiple frequency resources, a same spatial configuration, and a same power control parameter across the one or more SBFD resources and the one or more non-SBFD resources, in accordance with the first validity rule.

In some examples of the method, UEs, and non-transitory computer-readable medium described herein, the first slot includes a guard period between the one or more SBFD resources and the one or more non-SBFD resources and the valid RO spans the guard period, the one or more SBFD resources and the one or more non-SBFD resources.

Some examples of the method, UEs, and non-transitory computer-readable medium described herein may further include operations, features, means, or instructions for transmitting each portion of the PRACH preamble during the valid RO that spans the guard period, the one or more SBFD resources and the one or more non-SBFD resources, where the PRACH preamble may be associated with a same set of transmission parameters across the one or more SBFD resources and the one or more non-SBFD resources.

Some examples of the method, UEs, and non-transitory computer-readable medium described herein may further include operations, features, means, or instructions for dropping a portion of the PRACH preamble that spans the guard period during the valid RO, where the PRACH preamble may be associated with a first set of transmission parameters across the one or more SBFD resources and a second set of transmission parameters across the one or more non-SBFD resources.

Some examples of the method, UEs, and non-transitory computer-readable medium described herein may further include operations, features, means, or instructions for transmitting a first portion of the PRACH preamble associated with the one or more SBFD resources of the first slot prior to the guard period and dropping a second portion of the PRACH preamble associated with the one or more non-SBFD resources of the first slot after the guard period.

Some examples of the method, UEs, and non-transitory computer-readable medium described herein may further include operations, features, means, or instructions for transmitting a third portion of the PRACH preamble associated with resources during the guard period.

Some examples of the method, UEs, and non-transitory computer-readable medium described herein may further include operations, features, means, or instructions for dropping a first portion of the PRACH preamble associated with the one or more SBFD resources of the first slot spanning from a beginning of the first slot to and end of the guard period and transmitting a second portion of the PRACH preamble associated with the one or more non-SBFD resources of the first slot after to the guard period.

In some examples of the method, UEs, and non-transitory computer-readable medium described herein, the valid RO includes a set of multiple sequence repetitions and the valid RO may be valid based on the valid RO including a sequence repetition of the set of multiple sequence repetitions that may be aligned with a boundary between the one or more SBFD resources and the one or more non-SBFD resources, in accordance with the first validity rule.

In some examples of the method, UEs, and non-transitory computer-readable medium described herein, the valid RO spans the one or more SBFD resources and the one or more non-SBFD resources and the UE may be configured with a second RO that exclusively spans the one or more non-SBFD resources, the second RO including a time division duplex RO.

In some examples of the method, UEs, and non-transitory computer-readable medium described herein, the valid RO may be valid based on the valid RO spanning one or more first symbols across the one or more non-SBFD resources that may be non-overlapping with one or more second symbols associated with the second RO, in accordance with the first validity rule.

In some examples of the method, UEs, and non-transitory computer-readable medium described herein, the valid RO may be valid based on the valid RO and the second RO each mapping to a same synchronization signal block index, in accordance with the first validity rule.

In some examples of the method, UEs, and non-transitory computer-readable medium described herein, the valid RO may be valid based on the valid RO being associated with a first frequency span and the second RO being associated with a second frequency span and a frequency distance between the first frequency span and the second frequency span satisfies a threshold, in accordance with the first validity rule.

In some examples of the method, UEs, and non-transitory computer-readable medium described herein, the random access procedure may be a two-step random access procedure and the method, apparatuses, and non-transitory computer-readable medium may include further operations, features, means, or instructions for selecting a valid physical uplink shared channel (PUSCH) occasion from a set of multiple PUSCH occasions based on a second validity rule, where the second validity rule defines a validity of a PUSCH occasion when the PUSCH occasion may be associated with a second slot that spans one or more second SBFD resources and one or more second non-SBFD resources and transmitting, during the valid PUSCH occasion selected in accordance with the second validity rule, a data message.

In some examples of the method, UEs, and non-transitory computer-readable medium described herein, the second validity rule defines the validity of the valid PUSCH occasion based on the valid PUSCH occasion spanning exclusively the one or more second SBFD resources of the second slot or spanning exclusively the one or more second non-SBFD resources of the second slot.

In some examples of the method, UEs, and non-transitory computer-readable medium described herein, the second validity rule defines the validity of the valid PUSCH occasion based on the valid PUSCH occasion spanning the one or more second SBFD resources and the one or more second non-SBFD resources of the second slot, the one or more second SBFD resources and the one or more second non-SBFD resources may be directly adjacent in time, and the PUSCH occasion may be associated with a same set of multiple frequency resources, a same spatial configuration, and a same power control parameter across the one or more second SBFD resources and the one or more second non-SBFD resources of the second slot.

In some examples of the method, UEs, and non-transitory computer-readable medium described herein, the second slot includes a second guard period between the one or more second SBFD resources and the one or more second non-SBFD resources and the valid PUSCH occasion spans the second guard period, the one or more second SBFD resources and the one or more second non-SBFD resources.

Some examples of the method, UEs, and non-transitory computer-readable medium described herein may further include operations, features, means, or instructions for transmitting each portion of the data message during the valid PUSCH occasion that spans the second guard period, the one or more second SBFD resources and the one or more second non-SBFD resources, where the data message may be associated with a same set of transmission parameters across the one or more second SBFD resources and the one or more second non-SBFD resources.

Some examples of the method, UEs, and non-transitory computer-readable medium described herein may further include operations, features, means, or instructions for dropping a portion of the data message that spans the second guard period during the valid PUSCH occasion, where the data message may be associated with a first set of transmission parameters across the one or more second SBFD resources and a second set of transmission parameters across the one or more second non-SBFD resources.

Some examples of the method, UEs, and non-transitory computer-readable medium described herein may further include operations, features, means, or instructions for transmitting a first portion of the data message associated with the one or more second SBFD resources of the second slot prior to the second guard period and dropping a second portion of the data message associated with the one or more second non-SBFD resources of the second slot after the second guard period.

Some examples of the method, UEs, and non-transitory computer-readable medium described herein may further include operations, features, means, or instructions for transmitting a third portion of the data message associated with resources during the second guard period.

Some examples of the method, UEs, and non-transitory computer-readable medium described herein may further include operations, features, means, or instructions for dropping a first portion of the data message associated with the one or more second SBFD resources of the second slot spanning from a beginning of the second slot to and end of the second guard period and transmitting a second portion of the data message associated with the one or more second non-SBFD resources of the second slot after to the second guard period.

A method for wireless communications by a network entity is described. The method may include transmitting a configuration message that indicates to a UE a set of multiple ROs for performance of a random access procedure and receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

A network entity for wireless communications is described. The network entity may include one or more memories storing processor executable code, and one or more processors coupled with the one or more memories. The one or more processors may individually or collectively be operable to execute the code to cause the network entity to transmit a configuration message that indicates to a UE a set of multiple ROs for performance of a random access procedure and receive, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

Another network entity for wireless communications is described. The network entity may include means for transmitting a configuration message that indicates to a UE a set of multiple ROs for performance of a random access procedure and means for receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

A non-transitory computer-readable medium storing code for wireless communications is described. The code may include instructions executable by one or more processors to transmit a configuration message that indicates to a UE a set of multiple ROs for performance of a random access procedure and receive, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

In some examples of the method, network entities, and non-transitory computer-readable medium described herein, the valid RO may be valid based on the valid RO spanning exclusively the one or more SBFD resources of the first slot or spanning exclusively the one or more non-SBFD resources of the first slot, in accordance with the first validity rule.

In some examples of the method, network entities, and non-transitory computer-readable medium described herein, the valid RO may be valid based on the valid RO spanning the one or more SBFD resources and the one or more non-SBFD resources, the one or more SBFD resources and the one or more non-SBFD resources may be directly adjacent in time, and the valid RO may be associated with a same set of multiple frequency resources, a same spatial configuration, and a same power control parameter across the one or more SBFD resources and the one or more non-SBFD resources, in accordance with the first validity rule.

In some examples of the method, network entities, and non-transitory computer-readable medium described herein, the first slot includes a guard period between the one or more SBFD resources and the one or more non-SBFD resources and the valid RO spans the guard period, the one or more SBFD resources and the one or more non-SBFD resources.

Some examples of the method, network entities, and non-transitory computer-readable medium described herein may further include operations, features, means, or instructions for receiving each portion of the PRACH preamble during the valid RO that spans the guard period, the one or more SBFD resources and the one or more non-SBFD resources, where the PRACH preamble may be associated with a same set of transmission parameters across the one or more SBFD resources and the one or more non-SBFD resources.

Some examples of the method, network entities, and non-transitory computer-readable medium described herein may further include operations, features, means, or instructions for receiving a first portion of the PRACH preamble associated with the one or more SBFD resources of the first slot prior to the guard period.

Some examples of the method, network entities, and non-transitory computer-readable medium described herein may further include operations, features, means, or instructions for receiving a second portion of the PRACH preamble associated with resources during the guard period.

Some examples of the method, network entities, and non-transitory computer-readable medium described herein may further include operations, features, means, or instructions for receiving a first portion of the PRACH preamble associated with the one or more non-SBFD resources of the first slot after to the guard period.

In some examples of the method, network entities, and non-transitory computer-readable medium described herein, the valid RO includes a set of multiple sequence repetitions and the valid RO may be valid based on the valid RO including a sequence repetition of the set of multiple sequence repetitions that may be aligned with a boundary between the one or more SBFD resources and the one or more non-SBFD resources, in accordance with the first validity rule.

In some examples of the method, network entities, and non-transitory computer-readable medium described herein, the valid RO spans the one or more SBFD resources and the one or more non-SBFD resources and the UE may be scheduled with a second RO that exclusively spans the one or more non-SBFD resources, the second RO including a time division duplex RO.

In some examples of the method, network entities, and non-transitory computer-readable medium described herein, the valid RO may be valid based on the valid RO spanning one or more first symbols across the one or more non-SBFD resources that may be non-overlapping with one or more second symbols associated with the second RO, in accordance with the first validity rule.

In some examples of the method, network entities, and non-transitory computer-readable medium described herein, the valid RO may be valid based on the valid RO and the second RO each mapping to a same synchronization signal block index, in accordance with the first validity rule.

In some examples of the method, network entities, and non-transitory computer-readable medium described herein, the valid RO may be valid based on the valid RO being associated with a first frequency span and the second RO being associated with a second frequency span and a frequency distance between the first frequency span and the second frequency span satisfies a threshold, in accordance with the first validity rule.

In some examples of the method, network entities, and non-transitory computer-readable medium described herein, the random access procedure may be a two-step random access procedure and the method, apparatuses, and non-transitory computer-readable medium may include further operations, features, means, or instructions for receiving, during a valid PUSCH occasion of a set of multiple PUSCH occasions, a data message, where the valid PUSCH occasion may be based on a second validity rule, where the second validity rule defines a validity of a PUSCH occasion when the PUSCH occasion may be associated with a second slot that spans one or more second SBFD resources and one or more second non-SBFD resources.

In some examples of the method, network entities, and non-transitory computer-readable medium described herein, the second validity rule defines the validity of the valid PUSCH occasion based on the valid PUSCH occasion spanning exclusively the one or more second SBFD resources of the second slot or spanning exclusively the one or more second non-SBFD resources of the second slot.

In some examples of the method, network entities, and non-transitory computer-readable medium described herein, the second validity rule defines the validity of the valid PUSCH occasion based on the valid PUSCH occasion spanning the one or more second SBFD resources and the one or more second non-SBFD resources of the second slot, the one or more second SBFD resources and the one or more second non-SBFD resources may be directly adjacent in time, and the PUSCH occasion may be associated with a same set of multiple frequency resources, a same spatial configuration, and a same power control parameter across the one or more second SBFD resources and the one or more second non-SBFD resources of the second slot.

In some examples of the method, network entities, and non-transitory computer-readable medium described herein, the second slot includes a second guard period between the one or more second SBFD resources and the one or more second non-SBFD resources and the valid PUSCH occasion spans the second guard period, the one or more second SBFD resources and the one or more second non-SBFD resources.

Some examples of the method, network entities, and non-transitory computer-readable medium described herein may further include operations, features, means, or instructions for receiving each portion of the data message during the valid PUSCH occasion that spans the second guard period, the one or more second SBFD resources and the one or more second non-SBFD resources, where the data message may be associated with a same set of transmission parameters across the one or more second SBFD resources and the one or more second non-SBFD resources.

Some examples of the method, network entities, and non-transitory computer-readable medium described herein may further include operations, features, means, or instructions for receiving a first portion of the data message associated with the one or more second SBFD resources of the second slot prior to the second guard period.

Some examples of the method, network entities, and non-transitory computer-readable medium described herein may further include operations, features, means, or instructions for receiving a second portion of the data message associated with resources during the second guard period.

Some examples of the method, network entities, and non-transitory computer-readable medium described herein may further include operations, features, means, or instructions for receiving a first portion of the data message associated with the one or more second non-SBFD resources of the second slot after to the second guard period.

### BRIEF DESCRIPTION OF THE DRAWINGS

FIG. 1 shows an example of a wireless communications system that supports random access validation across multiple symbol types in accordance with one or more aspects of the present disclosure.

FIG. 2 shows an example of a wireless communications system that supports random access validation across multiple symbol types in accordance with one or more aspects of the present disclosure.

FIGS. 3A and 3B each show an example of a transmission occasion validation procedure that supports random access validation across multiple symbol types in accordance with one or more aspects of the present disclosure.

FIGS. 4A and 4B each show an example of a transmission occasion validation procedure that supports random access validation across multiple symbol types in accordance with one or more aspects of the present disclosure.

FIGS. 5A through 5D each show an example of a transmission occasion validation procedure that supports random access validation across multiple symbol types in accordance with one or more aspects of the present disclosure.

FIG. 6 shows an example of a random access channel (RACH) occasion validation procedure that supports random access validation across multiple symbol types in accordance with one or more aspects of the present disclosure.

FIG. 7 shows an example of a RACH occasion validation procedure that supports random access validation across multiple symbol types in accordance with one or more aspects of the present disclosure.

FIG. 8 shows an example of a process flow that supports random access validation across multiple symbol types in accordance with one or more aspects of the present disclosure.

FIGS. 9 and 10 show block diagrams of devices that support random access validation across multiple symbol types in accordance with one or more aspects of the present disclosure.

FIG. 11 shows a block diagram of a communications manager that supports random access validation across multiple symbol types in accordance with one or more aspects of the present disclosure.

FIG. 12 shows a diagram of a system including a device that supports random access validation across multiple symbol types in accordance with one or more aspects of the present disclosure.

FIGS. 13 and 14 show block diagrams of devices that support random access validation across multiple symbol types in accordance with one or more aspects of the present disclosure.

FIG. 15 shows a block diagram of a communications manager that supports random access validation across multiple symbol types in accordance with one or more aspects of the present disclosure.

FIG. 16 shows a diagram of a system including a device that supports random access validation across multiple symbol types in accordance with one or more aspects of the present disclosure.

FIGS. 17 through 20 show flowcharts illustrating methods that support random access validation across multiple symbol types in accordance with one or more aspects of the present disclosure.

### DETAILED DESCRIPTION

In some examples of wireless communications, a user equipment (UE) may perform a random access procedure with a network entity. For example, the network entity may configure the UE with one or more random access channel (RACH) occasions (ROs), over which the UE may transmit a random access preamble to request establishment of a wireless connection with the network entity. In some examples, the network entity may schedule a set of ROs across one or more physical RACH (PRACH) slots. Additionally, or alternatively, a PRACH slot may span a set of subband full duplex (SBFD) resources which allows for concurrent transmission and reception of data at the UE and may further span a set of non-SBFD resources (e.g., uplink resources or flexible resources). In some cases, however, if a given RO spans both SBFD and non-SBFD resources, the validity of a preamble transmission during the given RO may reduce. For instance, the SBFD and non-SBFD resources may be associated with different timing advances, different frequency allocations, different spatial beam allocations, and different power control parameters, which may reduce the reliability of preamble transmission.

The network entity and UE may increase the efficiency of preamble transmission by operating in accordance with the techniques described herein. For example, the UE and the network entity may use a validity rule to analyze whether a given RO is a valid RO for transmission of a random access preamble.

In some examples, the RO is valid based on the RO spanning exclusively SBFD resources of a PRACH slot or spanning exclusively the non-SBFD resources of the PRACH slot. In some cases, a similar rule may be used for validation of physical uplink shared channel (PUSCH) occasions (POs) for a two-step RO.

In some examples, an RO may be valid when spanning both SBFD and non-SBFD resources if one or more conditions are met. The conditions may include the SBFD and non-SBFD resources being directly adjacent in time (e.g., no time gap), and that the RO is associated with a same set of frequency resources, a same spatial configuration, and a same power control parameter across the SBFD resources and the non-SBFD resources. In some cases, a similar rule may be used for validation of POs for a two-step RO.

In some examples, an RO may be valid when spanning both SBFD and non-SBFD resources when there is a guard period (e.g., time gap) between the SBFD and non-SBFD resources. In some cases, the guard period may be referred to as a transient period. In a first example, the UE may ignore the guard period and transmit the RACH preamble during the entire RO. In a second example, the UE may drop the portion of the RACH preamble during the guard period but transmit the portions of the RACH preamble during the SBFD and non-SBFD resources. In a third example, the UE may drop the portion of the RACH preamble during non-SBFD resources and transmit exclusively during the SBFD resources. In a fourth example, the UE may drop the portion of the RACH preamble during SBFD resources and transmit exclusively during the non-SBFD resources. In some cases, a one or more similar rules may be used for validation of POs for a two-step RO.

In some examples, an RO may include a set of sequence repetitions, where the UE may transmit the RACH preamble during each sequence repetition. As such, an RO may be valid when spanning both SBFD and non-SBFD resources if one of the sequence repetitions of the RO aligns with a boundary between the SBFD and non-SBFD resources.

Additionally, or alternatively, the UE may be configured with a second RO that is time division duplex (TDD) RO scheduled exclusively for non-SBFD resources. As such, an RO may be valid based on how the RO overlaps with the second RO across time and frequency.

Aspects of the disclosure are initially described in the context of wireless communications systems, transmission occasion validation procedures, RO validation procedures, and a process flow. Aspects of the disclosure are further illustrated by and described with reference to apparatus diagrams, system diagrams, and flowcharts that relate to random access validation across multiple symbol types.

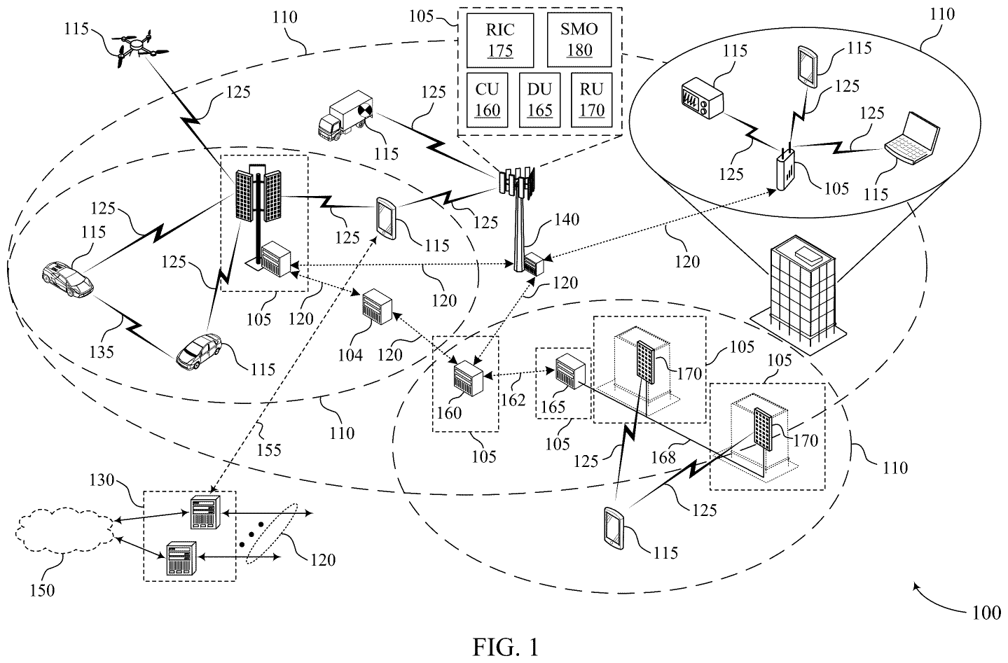

FIG. 1 shows an example of a wireless communications system 100 that supports random access validation across multiple symbol types in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100, a UE 115 may perform a random access procedure with a network entity 105. For example, the network entity 105 may configure the UE 115 with one or more ROs, over which the UE 115 may transmit a random access preamble to request establishment of a wireless connection with the network entity 105. In some examples, the network entity 105 may schedule a set of ROs across one or more PRACH slots. Additionally, or alternatively, a PRACH slot may span a set of SBFD resources which allows for concurrent transmission and reception of data at the UE 115 and may further span a set of non-SBFD resources (e.g., uplink resources or flexible resources). In some cases, however, if a given RO spans both SBFD and non-SBFD resources, the validity of a preamble transmission during the given RO may reduce. For instance, the SBFD and non-SBFD resources may be associated with different timing advances, different frequency allocations, different spatial beam allocations, and different power control parameters, which may reduce the reliability of preamble transmission.

The network entity 105 and UE 115 may increase the efficiency of preamble transmission by operating in accordance with the techniques described herein. For example, the UE 115 and the network entity 105 may use a validity rule to analyze whether a given RO is a valid RO for transmission of a random access preamble.

In some examples, the RO is valid based on the RO spanning exclusively SBFD resources of a PRACH slot or spanning exclusively the non-SBFD resources of the PRACH slot. In some cases, a similar rule may be used for validation of POs for a two-step RO.

In some examples, an RO may be valid when spanning both SBFD and non-SBFD resources if one or more conditions are met. The conditions may include the SBFD and non-SBFD resources being directly adjacent in time (e.g., no time gap), and that the RO is associated with a same set of frequency resources, a same spatial configuration, and a same power control parameter across the SBFD resources and the non-SBFD resources. In some cases, a similar rule may be used for validation of POs for a two-step RO.

In some examples, an RO may be valid when spanning both SBFD and non-SBFD resources when there is a guard period (e.g., time gap) between the SBFD and non-SBFD resources. In a first example, the UE 115 may ignore the guard period and transmit the RACH preamble during the entire RO. In a second example, the UE 115 may drop the portion of the RACH preamble during the guard period but transmit the portions of the RACH preamble during the SBFD and non-SBFD resources. In a third example, the UE 115 may drop the portion of the RACH preamble during non-SBFD resources and transmit exclusively during the SBFD resources. In a fourth example, the UE 115 may drop the portion of the RACH preamble during SBFD resources and transmit exclusively during the non-SBFD resources. In some cases, a one or more similar rules may be used for validation of POs for a two-step RO.

In some examples, an RO may include a set of sequence repetitions, where the UE 115 may transmit the RACH preamble during each sequence repetition. As such, an RO may be valid when spanning both SBFD and non-SBFD resources if one of the sequence repetitions of the RO aligns with a boundary between the SBFD and non-SBFD resources.

Additionally, or alternatively, the UE 115 may be configured with a second RO that is TDD-RO scheduled exclusively for non-SBFD resources. As such, an RO may be valid based on how the RO overlaps with the second RO across time and frequency.

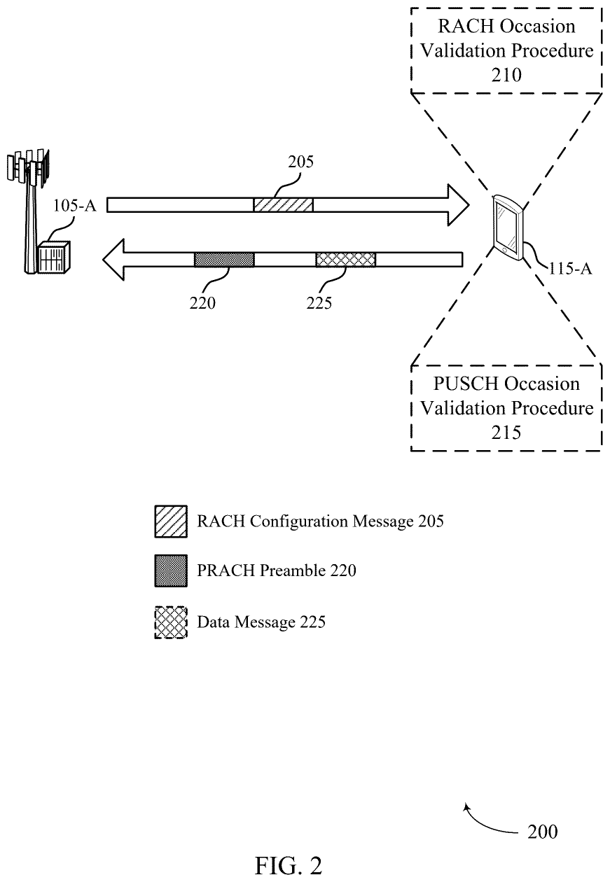

FIG. 2 shows an example of a wireless communications system 200 that supports random access validation across multiple symbol types in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples of wireless communications system 200, the UE 115-a and the network entity 105-a may operate in accordance with one or more random access procedures. For instance, the UE 115-a may use a random access procedure to initiate communication with the network entity 105-a when the UE 115-a may have data to send, when the UE 115-a desires to establish a connection with the network entity 105-a, or both. As part of the random access procedure, the UE 115-a may transmit to the network entity 105-a a PRACH preamble 220 via uplink, where the PRACH preamble 220 serves as a request for access to the network entity 105-a.

In some cases, the UE 115-a may use a contention based random access (CBRA) procedure. For example, in accordance with a CBRA procedure, the UE 115-a may select a PRACH preamble 220 from one or more pools of preambles that the UE 115-a shares with other UEs 115 associated with the network entity 105-a. As such, the network entity 105-a monitors for the preambles from the one or more pools and may allocate uplink resources to one or more UEs 115 that successfully transmit respective preambles without collision. In cases of collision, a given UE 115-a may retry the CBRA procedure using a different preamble (e.g., after a configured random access backoff period). In some examples, CBRA may be suitable for scenarios with a large quantity of UEs 115 and varying traffic loads, as CBRA may allow for flexible and dynamic access to the network entity 105-a. Additionally, or alternatively, a CBRA procedure may be referred to as a four-step RACH procedure.

In some cases, the UE 115-a may use a contention free random access (CFRA) procedure. In accordance with a CFRA procedure, collision-free access to network resources may be ensured through scheduled access. For example, the network entity 105-a may allocate one or more UEs 115 with respective time slots or resources, which may reduce UE 115-a contention and PRACH preamble 220 collisions. In some examples, CFRA scheduled access may be based on various factors such as quality of service parameters, traffic prioritization, or pre-negotiated access agreements. As such, CFRA may be advantageous in scenarios where an increase in quality of service is favorable or where contention-based access may result in excessive collisions and delays. Additionally, or alternatively, a CFRA procedure may be referred to as a two-step RACH procedure.

In some cases, the UE 115-a may perform a given RACH procedure (e.g., CBRA or CFRA) in accordance with one or more ROs. For example, a set of ROs may refer to respective time intervals within the communication protocol where the UE 115-a may initiate the RACH procedure to access the network entity 105-a. In some examples, the UE 115-a may determine a set of ROs based on receiving a RACH configuration message 205. For instance, the RACH configuration message 205 may be an example of a PRACH configuration (e.g., as part of RRC configuration) which may configure one or more tables including respective PRACH configurations. As such, the RACH configuration message 205, or a second control message, may indicate an index associated with the one or more tables of the PRACH configuration. For instance, the index may indicate a preamble format, a PRACH period, a PRACH slot, and a quantity of ROs per PRACH slot.

In some examples, the UE 115-a and network entity 105-a may determine to operate in accordance with a two-step RACH (e.g., instead of a four-step RACH) based on one or more advantages. For example, a two-step RACH procedure may be associated with reduced latency and signaling overhead compared to a four-step RACH procedure. Additionally, or alternatively, a two-step RACH procedure may support timing advance (TA) free and grant-free small uplink packet transmission using a different transport block size (TBS), a different modulation and coding scheme (MCS), or both. Additionally, or alternatively, a two-step RACH procedure may be associated with an increase message load capacity and power efficiency compared to four-step RACH procedure.

In cases of two-step RACH, the UE 115-a may be further configured with a set of POs that may be associated with the set of configured ROs. For example, similar to an RO which may include time and frequency resources allocated for a msgA PRACH preamble 220 transmission, a PO may include time and frequency resources allocated for a msgA PUSCH transmission (e.g., a data transmission). To support asynchronous uplink transmission in a two-step RACH, a guard time (GT) and a guard band (GB) may be configured for each PO to mitigate inter-carrier interference (ICI) and inter-symbol interference (ICI).

Additionally, or alternatively, a given RO may be associated with a respective set of POs. For example, if the UE 115-a selects a first RO from a set of configured ROs for transmission of a PRACH preamble 220, the first RO may be associated with a set of POs, where the UE 115-a may select a first PO from the set of POs for transmission of the PUSCH transmission. Additionally, or alternatively, a msgA transmission of the two-step RACH procedure may be associated with a PUSCH resource unit (PRU), which may indicate a PO and a demodulation reference signal (DMRS) port or sequence used for the msgA payload transmission.

In cases of both four-step RACH (e.g., type-1 RACH) and two-step RACH (e.g., type-2 RACH), a configured PRACH slot may span different types of symbols. For example, a PRACH slot may span both SBFD symbols and non-SBFD symbols. As described herein, an SBFD symbol may include both uplink resources and downlink resources which may allow for concurrent transmission and reception of data at the UE 115-a. Additionally, or alternatively, a non-SBFD symbol may include either uplink resources or flexible resources that may allow for the UE 115-a to transmit data. In a first example, a PRACH slot (e.g., that includes one or more ROs) may span a single slot that includes both SBFD resources and non-SBFD resources (e.g., a mixed slot). In a second example, a PRACH slot (e.g., that includes one or more ROs) may span multiple SBFD and non-SBFD slots (e.g., for a long PRACH preamble 220 sequence type). Additionally, or alternatively, a type-2 RACH may include a PUSCH slot (e.g., that includes one or more POs), where the PUSCH slot spans SBFD and non-SBFD symbols.

In some cases, however, if a given RO spans both SBFD and non-SBFD resources, the validity of a preamble transmission during the given RO may be reduced. For instance, the SBFD and non-SBFD resources may be associated with different timing advances, different frequency allocations, different spatial beam allocations, and different power control parameters, which may reduce the reliability of preamble transmission. Similarly, a given PO that spans both SBFD and non-SBFD resources may reduce the validity of a PUSCH transmission during the given PO.

The network entity 105-a and UE 115-a may increase the efficiency of preamble transmission and PUSCH transmission by operating in accordance with the techniques described herein. For example, the UE 115-a and the network entity 105-a may use one or more validity rules to analyze whether a given RO is a valid RO for transmission of a PRACH preamble 220. For instance, as illustrated is FIG. 2 the UE 115-a may operate in accordance with a first validity rule to perform a RACH occasion validation procedure 210 to determine whether a given RO is valid. As such, the UE 115-a may select a valid RO (e.g., in accordance with RACH occasion validation procedure 210), during which the UE 115-a may transmit the PRACH preamble 220. Additionally, or alternatively, for a two-step RACH procedure the UE 115-a may operate in accordance with a second validity rule to perform a PUSCH occasion validation procedure 215 to determine whether a given PO is valid. As such, the UE 115-a may select a valid PO (e.g., in accordance with PUSCH occasion validation procedure 215), during which the UE 115-a may transmit a data message 225 (e.g., a PUSCH transmission).

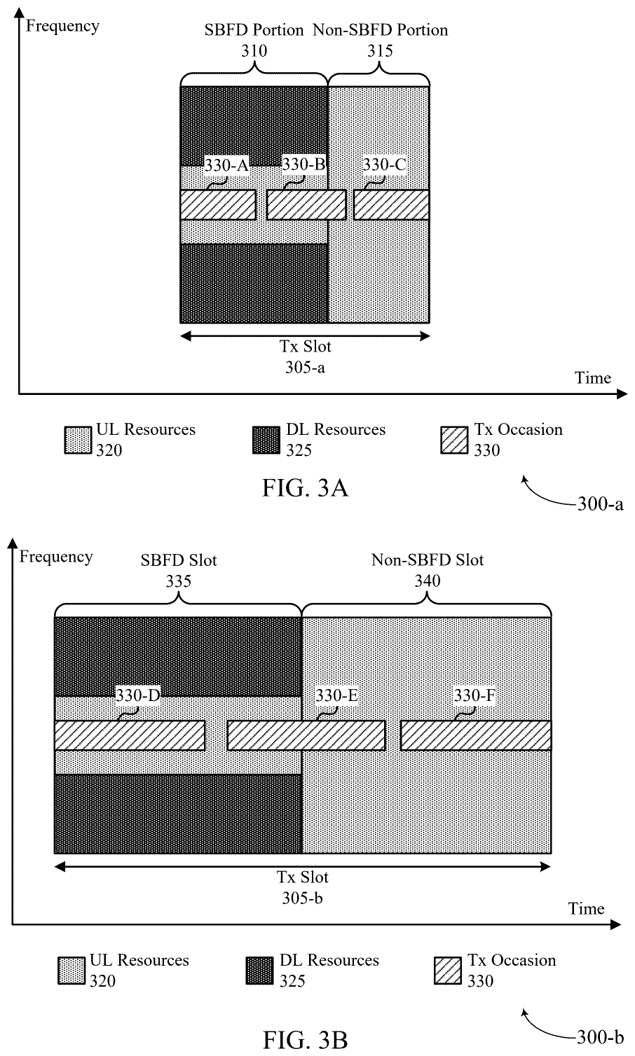

In some examples, the RO is valid based on the RO spanning exclusively SBFD resources of a PRACH slot or spanning exclusively the non-SBFD resources of the PRACH slot. In some cases, a similar rule may be used for validation of POs for a two-step RACH. Further discussion of such a validity rule is described with reference to FIGS. 3A and 3B.

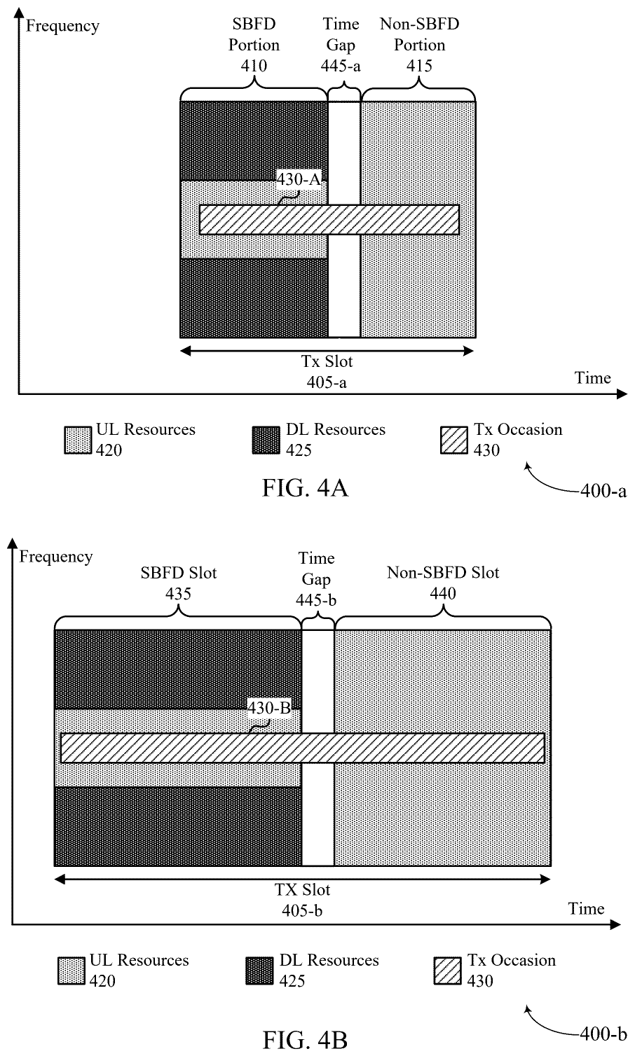

In some examples, an RO may be valid when spanning both SBFD and non-SBFD resources if one or more conditions are met. The conditions may include the SBFD and non-SBFD resources being directly adjacent in time (e.g., no time gap), and that the RO is associated with a same set of frequency resources, a same spatial configuration, and a same power control parameter across the SBFD resources and the non-SBFD resources. In some cases, a similar rule may be used for validation of POs for a two-step RACH. Further discussion of such a validity rule is described with reference to FIGS. 4A and 4B.

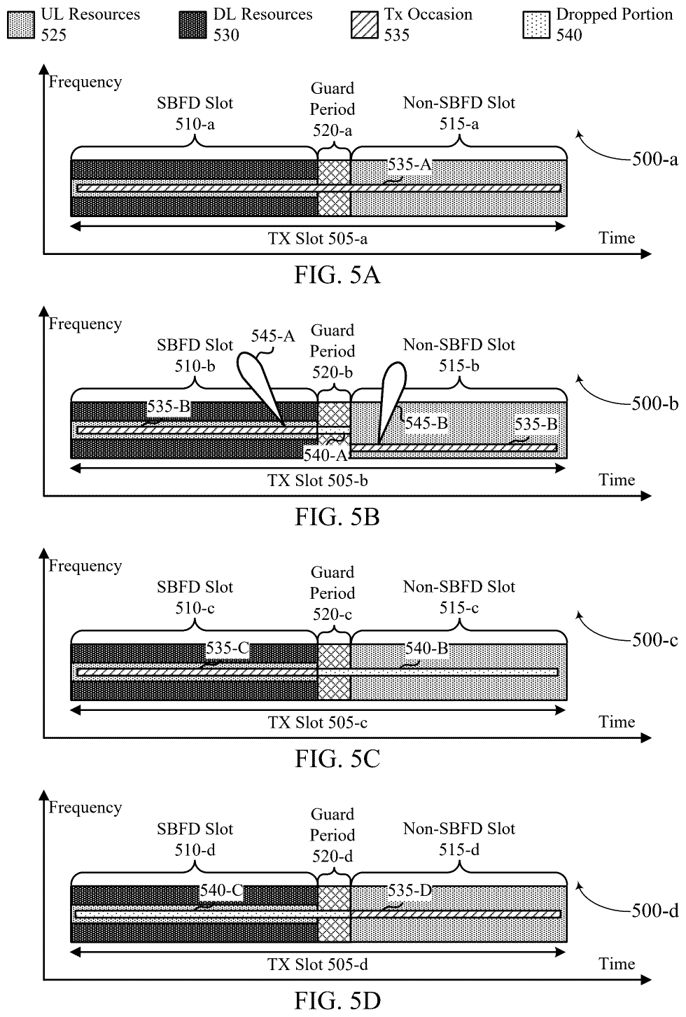

In some examples, an RO may be valid when spanning both SBFD and non-SBFD resources when there is a guard period (e.g., time gap) between the SBFD and non-SBFD resources. In a first example, the UE 115-a may ignore the guard period and transmit the RACH preamble during the entire RO. In a second example, the UE 115-a may drop the portion of the RACH preamble during the guard period but transmit the portions of the RACH preamble during the SBFD and non-SBFD resources. In a third example, the UE 115-a may drop the portion of the RACH preamble during non-SBFD resources and transmit exclusively during the SBFD resources. In a fourth example, the UE 115-a may drop the portion of the RACH preamble during SBFD resources and transmit exclusively during the non-SBFD resources. In some cases, one or more similar rules may be used for validation of POs for a two-step RACH. Discussion of such validity rules are described with reference to FIGS. 5A through 5D.

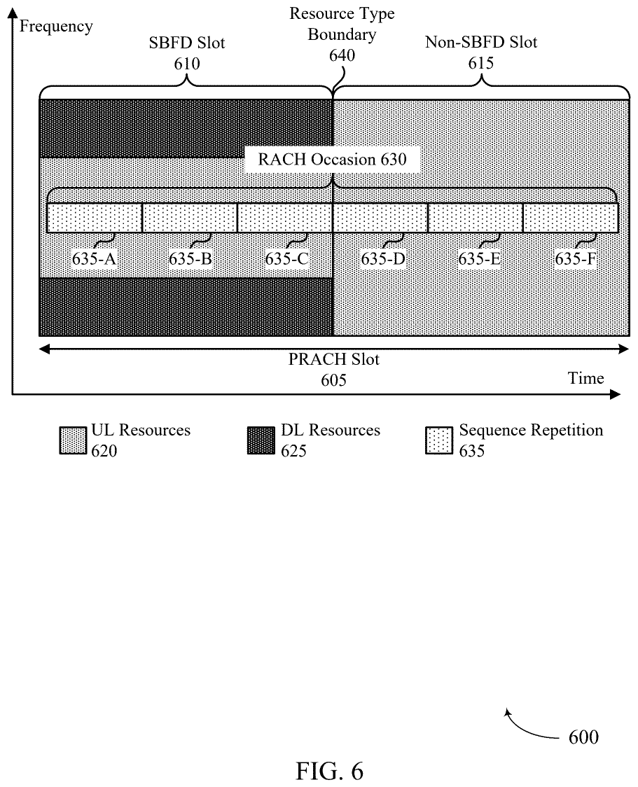

In some examples, an RO may include a set of sequence repetitions, where the UE 115-a may transmit the RACH preamble during each sequence repetition. As such, an RO may be valid when spanning both SBFD and non-SBFD resources if one of the sequence repetitions of the RO aligns with a boundary between the SBFD and non-SBFD resources. Discussion of such a validity rule is described with reference to FIG. 6.

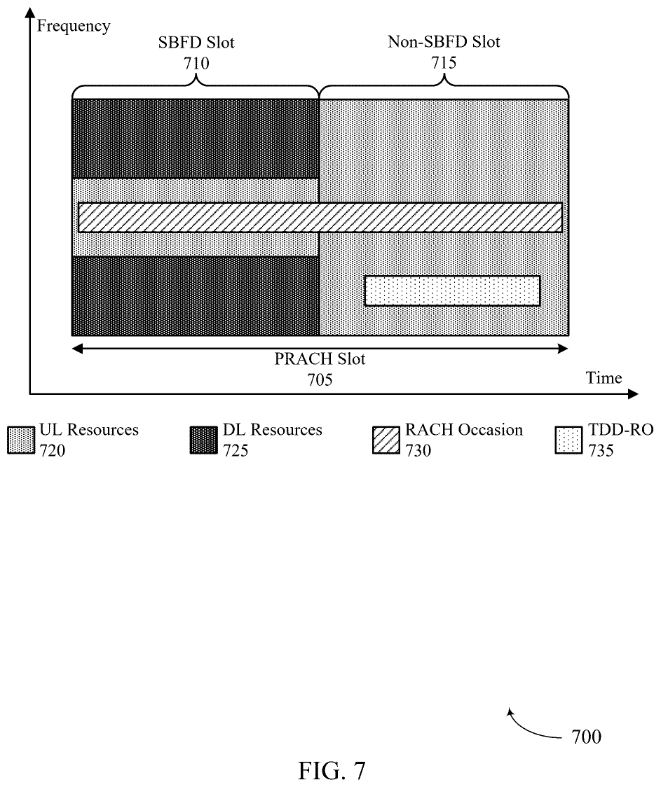

Additionally, or alternatively, the UE 115-a may be configured with a second RO that is TDD-RO scheduled exclusively for non-SBFD resources. As such, an RO that spans both SBFD and non-SBFD resources may be valid based on how the RO overlaps with the second RO across time and frequency. Discussion of such a validity rule is described with reference to FIG. 7.

FIGS. 3A and 3B respectively show an example of a transmission occasion validation procedure 300-a 300-b that each support random access validation across multiple symbol types in accordance with one or more aspects of the present disclosure. The transmission occasion validation procedure 300-a and 300-b may implement or may be implemented by aspects of the wireless communications system 100 and 200. For example, the transmission occasion validation procedure 300-a and 300-b may use techniques of RACH occasion validation procedure 210, of PUSCH occasion validation procedure 215, or both. Additionally, the techniques described with reference to transmission occasion validation procedure 300-a and 300-b may be performed by a network entity 105, a UE 115, or both.

As illustrated with reference to FIG. 3A, the UE 115 may be configured with a transmission slot 305-a that spans a single slot including an SBFD portion 310 and a non-SBFD portion 315. As such, the SBFD portion 310 may include both uplink resources 320 and downlink resources 325 and the non-SBFD portion may include uplink resources 320 (e.g., or flexible resources configured for uplink in other examples). Additionally, the transmission slot 305-a may include multiple transmission occasions 330 (e.g., transmission occasion 330-a, 330-b, and 330-c).

In some cases, the transmission slot 305-a may be a PRACH slot, where each of transmission occasion 330-a, 330-b, and 330-c are respective ROs. When the UE 115 is configured with an RO of either type-1 RACH or type-2 RACH in the PRACH slot that spans both SBFD resources and non-SBFD resources, the UE 115 may operate in accordance with a first validity rule used for performing RACH occasion validation procedure 210. For example, the first validity rule may determine that a valid RO may exclusively span a same symbol type within the PRACH slot (e.g., valid ROs may exclusively span SBFD symbols or exclusively span non-SBFD symbols). That is, with reference to FIG. 3A and in accordance with the first validity rule, the UE 115 and network entity 105 may determine that transmission occasion 330-a is a valid RO based on spanning exclusively SBFD symbols of the SBFD portion 310, determine that transmission occasion 330-c is a valid RO based on spanning exclusively non-SBFD symbols of the non-SBFD portion 315, and determine that transmission occasion 330-b is not a valid RO based on spanning symbols of both SBFD portion 310 and non-SBFD portion 315. As such, the UE 115 may select to transmit a PRACH preamble during transmission occasion 310-a or 310-c based on determining the validity of transmission occasion 310-a or 310-c in accordance with the first validity rule.

In some cases, the transmission slot 305-a may be a PUSCH slot, where each of transmission occasion 330-a, 330-b, and 330-c are respective POs. When the UE 115 is configured with a PO of type-2 RACH in the PUSCH slot that spans both SBFD resources and non-SBFD resources, the UE 115 may operate in accordance with a second validity rule used for performing PUSCH occasion validation procedure 215. For example, the second validity rule may determine that a valid PO may exclusively span a same symbol type within the PUSCH slot (e.g., valid POs may exclusively span SBFD symbols or exclusively span non-SBFD symbols). That is, with reference to FIG. 3A and in accordance with the second validity rule, the UE 115 and network entity 105 may determine that transmission occasion 330-a is a valid PO based on spanning exclusively SBFD symbols of the SBFD portion 310, determine that transmission occasion 330-c is a valid PO based on spanning exclusively non-SBFD symbols of the non-SBFD portion 315, and determine that transmission occasion 330-b is not valid a PO based on spanning symbols of both SBFD portion 310 and non-SBFD portion 315. As such, the UE 115 may select to transmit a data message during transmission occasion 310-a or 310-c based on determining the validity of transmission occasion 310-a or 310-c in accordance with the second validity rule.

As illustrated with reference to FIG. 3B, the UE 115 may be configured with a transmission slot 305-b that spans an SBFD slot 335 that includes SBFD symbols and a non-SBFD slot 340 that spans non-SBFD symbols. As such, the SBFD slot 335 may include both uplink resources 320 and downlink resources 325 and the non-SBFD slot 340 may include uplink resources 320 (e.g., or flexible resources configured for uplink in other examples). Additionally, the transmission slot 305-b may include multiple transmission occasions 330 (e.g., transmission occasion 330-d, 330-f, and 330-e).

In some cases, the transmission slot 305-b may be a PRACH slot, where each of transmission occasion 330-d, 330-e, and 330-f are respective ROs. In such cases, the UE 115 and network entity 105 may operate in accordance with the first validity rule as described with reference to FIG. 3A. That is, the UE 115 and network entity 105 may determine that transmission occasion 330-d is a valid RO based on spanning exclusively SBFD symbols of the SBFD slot 335, determine that transmission occasion 330-f is a valid RO based on spanning exclusively non-SBFD symbols of the non-SBFD slot 340, and determine that transmission occasion 330-e is not a valid RO based on spanning symbols of both SBFD slot 335 and non-SBFD slot 340. As such, the UE 115 may select to transmit a PRACH preamble during transmission occasion 310-d or 310-f based on determining the validity of transmission occasion 310-d or 310-f in accordance with the first validity rule.

In some cases, the transmission slot 305-b may be a PUSCH slot, where each of transmission occasion 330-d, 330-e, and 330-f are respective POs. In such cases, the UE 115 and network entity 105 may operate in accordance with the second validity rule as described with reference to FIG. 3B. That is, the UE 115 and network entity 105 may determine that transmission occasion 330-d is a valid PO based on spanning exclusively SBFD symbols of the SBFD slot 335, determine that transmission occasion 330-f is a valid PO based on spanning exclusively non-SBFD symbols of the non-SBFD slot 340, and determine that transmission occasion 330-e is not a valid PO based on spanning symbols of both SBFD slot 335 and non-SBFD slot 340. As such, the UE 115 may select to transmit a data message during transmission occasion 310-d or 310-f based on determining the validity of transmission occasion 310-d or 310-f in accordance with the second validity rule.

FIGS. 4A and 4B respectively show an example of a transmission occasion validation procedure 400-a and 400-b that each support random access validation across multiple symbol types in accordance with one or more aspects of the present disclosure. The transmission occasion validation procedure 400-a and 400-b may implement or may be implemented by aspects of the wireless communications system 100 and 200. For example, the transmission occasion validation procedure 400-a and 400-b may use techniques of RACH occasion validation procedure 210, of PUSCH occasion validation procedure 215, or both. Additionally, the techniques described with reference to transmission occasion validation procedure 400-a and 400-b may be performed by a network entity 105, a UE 115, or both.

As illustrated with reference to FIG. 4A, the UE 115 may be configured with a transmission slot 405-a that spans a single slot including an SBFD portion 410 and a non-SBFD portion 415. As such, the SBFD portion 410 may include both uplink resources 420 and downlink resources 425 and the non-SBFD portion may include uplink resources 420 (e.g., or flexible resources configured for uplink in other examples). Additionally, the transmission slot 405-a may include a transmission occasion 430-a. Additionally, or alternatively, the transmission slot may include a time gap 445-a between the SBFD portion 410 and the non-SBFD portion 415.

In some cases, the transmission slot 405-a may be a PRACH slot, where the transmission occasion 430-a is an RO. When the UE 115 is configured with an RO of either type-1 RACH or type-2 RACH that spans both SBFD resources and non-SBFD resources, the UE 115 may operate in accordance with a first validity rule used for performing RACH occasion validation procedure 210. For example, the first validity rule may determine a valid RO if one or more conditions are satisfied. For example, the one or more conditions may include time gap 445-a being equal to zero (e.g., no time gap between the SBFD symbols and non-SBFD symbols, including no change of TA), a same resource allocation for the RO between the SBFD portion 410 and the non-SBFD portion 415 (e.g., same narrow uplink resource allocation), a same spatial relationship between the SBFD portion 410 and the non-SBFD portion 415 (e.g., a same uplink beam or a same spatial relation information configuration), a same power control parameter between the SBFD portion 410 and the non-SBFD portion 415 (e.g., same uplink transmission parameters), or a combination thereof.

In some cases, the transmission slot 405-a may be a PUSCH slot, where the transmission occasion 430-a is a PO. When the UE 115 is configured with a PO for type-2 RACH that spans both SBFD resources and non-SBFD resources, the UE 115 may operate in accordance with a second validity rule used for performing PUSCH occasion validation procedure 215. For example, the second validity rule may determine a valid PO if one or more conditions are satisfied. For example, the one or more conditions may include time gap 445-a being equal to zero (e.g., no time gap between the SBFD symbols and non-SBFD symbols, including no change of TA), a same resource allocation for the RO between the SBFD portion 410 and the non-SBFD portion 415 (e.g., same narrow uplink resource allocation), a same spatial relationship between the SBFD portion 410 and the non-SBFD portion 415 (e.g., a same uplink beam or a same spatial relation information configuration), a same power control parameter between the SBFD portion 410 and the non-SBFD portion 415 (e.g., same uplink transmission parameters), or a combination thereof.

As illustrated with reference to FIG. 4B, the UE 115 may be configured with a transmission slot 405-b that spans an SBFD slot 435 that includes SBFD symbols and a non-SBFD slot 440 that spans non-SBFD symbols. As such, the SBFD slot 435 may include both uplink resources 420 and downlink resources 425 and the non-SBFD slot 440 may include uplink resources 420 (e.g., or flexible resources configured for uplink in other examples). Additionally, the transmission slot 405-b may include transmission occasion 430-b. Additionally, or alternatively, the transmission slot may include a time gap 445-b between the SBFD slot 435 and the non-SBFD slot 440.

In some cases, the transmission slot 405-b may be a PRACH slot, where the transmission occasion 430-b is an RO. In such cases, the UE 115 and network entity 105 may operate in accordance with the first validity rule as described with reference to FIG. 4A. That is, the UE 115 and network entity 105 may determine that transmission occasion 430-b is a valid RO based on whether the RO satisfies the one or more conditions described with reference to FIG. 4A.

In some cases, the transmission slot 405-b may be a PUSCH slot, where the transmission occasion 430-b is a PO. In such cases, the UE 115 and network entity 105 may operate in accordance with the second validity rule as described with reference to FIG. 4A. That is, the UE 115 and network entity 105 may determine that transmission occasion 430-b is a valid PO based on whether the PO satisfies the one or more conditions described with reference to FIG. 4A.

FIG. 5A through 5D respectively show an example of a transmission occasion validation procedure 500-a, 500-b, 500-c, and 500-d that each support random access validation across multiple symbol types in accordance with one or more aspects of the present disclosure. The transmission occasion validation procedure 500-a, 500-b, 500-c, and 500-d may implement or may be implemented by aspects of the wireless communications system 100 and 200. For example, the transmission occasion validation procedure 500-a, 500-b, 500-c, and 500-d may use techniques of RACH occasion validation procedure 210, of PUSCH occasion validation procedure 215, or both. Additionally, the techniques described with reference to transmission occasion validation procedure 500-a, 500-b, 500-c, and 500-d may be performed by a network entity 105, a UE 115, or both.

As illustrated with reference to FIGS. 5A through 5D the UE 115 may be configured with a transmission slot 505 (e.g., transmission slot 505-a, 505-b, 505-c, and 505-d respectively) that spans an SBFD slot 510 (e.g., SBFD slot 510-a, 510-b, 510-c, and 510-d respectively) and a non-SBFD slot 515 (e.g., non-SBFD slot 515-a, 515-b, 515-c, and 515-d respectively). As described herein, the SBFD slot 510 may include both uplink resources 525 and downlink resources 530 and the non-SBFD slot 515 may include uplink resources 525. Additionally, each of FIGS. 5A through 5D may include a guard period 520 (e.g., guard period 520-a, 520-b, 520-c, and 520-d respectively) between the SBFD slot 510 and the non-SBFD slot 515. Additionally, while FIGS. 5A through 5D each illustrate their respective transmission slot 505 spanning an SBFD slot 510 and a non-SBFD slot 515, it is understood that each transmission slot 505 may correspond to a single mixed slot that includes an SBFD portion and a non-SBFD portion (e.g., similar to examples provided with reference to FIGS. 3A and 4A). Additionally, while FIGS. 5A through 5D each illustrate the SBFD portion occurring prior to the gap period 520 and the non-SBFD portion occurring after the gap period 520, it is understood that the non-SBFD portion may occur prior to the gap period 520 and the SBFD portion may occur after the gap period 520.

Additionally, each of FIGS. 5A through 5D may include a transmission occasion 535 (e.g., transmission occasion 535-a, 535-b, 535-c, and 535-d respectively) that spans each of the SBFD slot 510, the guard period 520, and the non-SBFD slot 515. Additionally, or alternatively, each of the transmission occasions 535 may be an example of a valid RO (e.g., where the transmission slot 505 is a PRACH slot) or a valid PO (e.g., where the transmission slot is a PUSCH slot). As such, FIGS. 5A through 5D each show a respective technique used by the UE 115 to transmit during the valid transmission occasion 535.

As illustrated in FIG. 5A, the UE 115 may determine to ignore the guard period 520-a, and transmit information during the span of the transmission occasion 535-a. For example, if the transmission occasion 535-a is a valid RO, then the UE 115 may transmit a PRACH preamble during the SBFD slot 510-a, during the guard period 520-a, and during the non-SBFD slot 515-a. If the transmission occasion 535-a is a valid PO, then the UE 115 may transmit a data message during the SBFD slot 510-a, during the guard period 520-a, and during the non-SBFD slot 515-a. In some examples, the UE 115 may use a same set of transmission parameters across both the SBFD symbols and the non-SBFD symbols of the transmission occasion 535-a (e.g., a same beam, a same transmission power, and a same frequency).

As illustrated in FIG. 5B, the UE 115 may determine to drop a portion of a transmission for the transmission occasion 535-b. For example, if the transmission occasion 535-b is a valid RO, the UE 115 may drop a portion of the PRACH preamble that spans the guard period (e.g., dropped portion 540-a). If the transmission occasion 535-b is a valid PO, the UE 115 may drop a portion of the data message that spans the guard period (e.g., dropped portion 540-a). As such, the UE 115 may resume transmission (e.g., of either the PRACH preamble or data message) after the guard period. As illustrated in FIG. 5B, the UE 115 may additionally change one or more transmission parameters associated with the transmission occasion 535-b before and after the guard period 520-b. For example, the transmission occasion 535-b may be associated with a first beam 545-a during the SBFD slot 510-b and associated with a second beam 545-b during the non-SBFD slot 515-b. Additionally, or alternatively, the transmission occasion 535-b may be associated with a frequency span during the SBFD slot 510-b and associated with a second different frequency span during the non-SBFD slot 515-b. Additionally, or alternatively, the transmission occasion 535-b may be associated with a first transmission power during the SBFD slot 510-b and associated with a second different transmission power during the non-SBFD slot 515-b.

As illustrated in FIG. 5C, the UE 115 may determine to drop a portion of a transmission for the transmission occasion 535-c that occurs after the guard period 520-c. For example, if the transmission occasion 535-c is a valid RO, the UE 115 may drop a portion of the PRACH preamble that occurs after the guard period 520-c (e.g., dropped portion 540-b). If the transmission occasion 535-c is a valid PO, the UE 115 may drop a portion of the data message that occurs after the guard period 520-c (e.g., dropped portion 540-b). In some cases, the dropped portion 540-b may include the guard period 520-c (e.g., as illustrated in FIG. 5C), or alternatively the UE 115 may determine to transmit during the guard period 520-c.

As illustrated in FIG. 5D, the UE 115 may determine to drop a portion of a transmission for the transmission occasion 535-d that occurs prior to the end the guard period 520-d. For example, if the transmission occasion 535-c is a valid RO, the UE 115 may drop a portion of the PRACH preamble that occurs prior to the end of the guard period 520-c (e.g., dropped portion 540-c). If the transmission occasion 535-c is a valid PO, the UE 115 may drop a portion of the data message that occurs prior to the end of the guard period 520-c (e.g., dropped portion 540-c).

FIG. 6 shows an example of a RACH occasion validation procedure 600 that supports random access validation across multiple symbol types in accordance with one or more aspects of the present disclosure. The RACH occasion validation procedure 600 may implement or may be implemented by aspects of the wireless communications system 100 and 200. For example, the RACH occasion validation procedure 600 may use techniques of RACH occasion validation procedure 210. Additionally, the techniques described with reference to RACH occasion validation procedure 600 may be performed by a network entity 105, a UE 115, or both.

As illustrated with reference to FIG. 6, the UE 115 may be configured with a PRACH slot 605 that spans an SBFD slot 610 that includes SBFD symbols and a non-SBFD slot 615 that spans non-SBFD symbols. As such, the SBFD slot 635 may include both uplink resources 620 and downlink resources 625 and the non-SBFD slot 615 may include uplink resources 620 (e.g., or flexible resources configured for uplink in other examples). Additionally, the PRACH slot 605 may include an RO 630. Additionally, while FIG. 6 illustrates the PRACH slot 605 spanning an SBFD slot 610 and a non-SBFD slot 615, it is understood that the PRACH slot 605 may correspond to a single mixed slot that includes an SBFD portion and a non-SBFD portion (e.g., similar to examples provided with reference to FIGS. 3A and 4A). Additionally, while FIG. 6 illustrates the SBFD portion occurring prior the non-SBFD portion, it is understood that the non-SBFD portion may occur prior to the SBFD portion.

As illustrated in FIG. 6, the PRACH preamble associated with the RO 630 may be configured with a set of sequence repetitions 635. For example, FIG. 6 illustrates a PRACH preamble with sequence repetition 635-a, 635-b, and 635-c that span the symbols of the SBFD slot 610 and sequence repetition 635-d, 635-e, and 635-f that span the symbols of the non-SBFD slot 615. In some examples, a given sequence repetition 635 may include a set of information associated with transmission of a PRACH preamble, where each sequence repetition 635 includes the same set of information. The inclusion of multiple sequence repetitions 635 in the RO occasion may increase the likelihood of a successful PRACH preamble transmission from the UE 115 to the network entity 105.

When the UE 115 is configured with the RO 630 of either type-1 RACH or type-2 RACH that includes multiple sequence repetitions 635 and spans both SBFD resources and non-SBFD resources, the UE 115 may operate in accordance with a first validity rule used for performing RACH occasion validation procedure 600. For example, the first validity rule may determine that the RO 630 is valid if a boundary between the SBFD symbols and the non-SBFD symbols aligns with a start of a given sequence repetition. For example, a resource type boundary 640 may be boundary that establishes the end of the SBFD resources of SBFD slot 610 and the start of the non-SBFD resources of non-SBFD slot 615 (e.g., or vice versa). Based on the start of sequence repetition 635-d aligning with the resource type boundary 640, the UE 115 and network entity 105 may determine that the RO 630 is valid. As such, the UE 115 may select to transmit a PRACH preamble during the RO 630 based on determining that the RO 630 is valid in accordance with the first validity rule.

FIG. 7 shows an example of a RACH occasion validation procedure 700 that supports random access validation across multiple symbol types in accordance with one or more aspects of the present disclosure. The RACH occasion validation procedure 700 may implement or may be implemented by aspects of the wireless communications system 100 and 200. For example, the RACH occasion validation procedure 700 may use techniques of RACH occasion validation procedure 210. Additionally, the techniques described with reference to RACH occasion validation procedure 700 may be performed by a network entity 105, a UE 115, or both.

As illustrated with reference to FIG. 7, the UE 115 may be configured with a PRACH slot 705 that spans an SBFD slot 710 that includes SBFD symbols and a non-SBFD slot 715 that spans non-SBFD symbols. As such, the SBFD slot 710 may include both uplink resources 720 and downlink resources 725 and the non-SBFD slot 715 may include uplink resources 720 (e.g., or flexible resources configured for uplink in other examples). Additionally, the PRACH slot 705 may include an RO 730. Additionally, while FIG. 7 illustrates the PRACH slot 705 spanning an SBFD slot 710 and a non-SBFD slot 715, it is understood that the PRACH slot 705 may correspond to a single mixed slot that includes an SBFD portion and a non-SBFD portion (e.g., similar to examples provided with reference to FIGS. 3A and 4A). Additionally, while FIG. 7 illustrates the SBFD portion occurring prior the non-SBFD portion, it is understood that the non-SBFD portion may occur prior to the SBFD portion.

As illustrated in FIG. 7, the PRACH slot 705 may further include a TDD-RO 735 that exclusively spans the non-SBFD slot 715 of the PRACH slot 705. As such, the RO 730 and the TDD-RO 735 may partially overlap in frequency, partially overlap in time, or both. When the UE 115 is configured with the RO 730 of either type-1 RACH or type-2 RACH that spans both SBFD resources and non-SBFD resources and is configured with the TDD-RO 735, the UE 115 may operate in accordance with a first validity rule used for performing RACH occasion validation procedure 700.

In a first example, the UE 115 may determine the RO 730 is valid if the RO 730 does not overlap with one or more OFDM symbols of the TDD-RO 735 in the non-SBFD slot 715. In a second example, the UE 115 may determine the RO 730 is valid if the RO 730 and the TDD-RO 735 overlap with one or more OFDM symbols and map to a same SSB index (e.g., are associated with a same SSB). In a third example, the UE 115 may determine the RO 730 is valid if there is a minimum frequency separation between the RO 730 and the TDD-RO 735. For instance, if the RO 730 spans a first frequency bandwidth and the TDD-RO 735 spans a second frequency bandwidth, where a frequency separation between the first frequency bandwidth and the second frequency bandwidth is greater than a configured threshold (e.g., satisfies the configured threshold), then the RO 730 may be valid.

In some cases, the UE 115 may use one of the techniques described with reference to the first, second, and third example to determine the validity of the RO 730. In some cases, the UE 115 may use a combination of the techniques described with reference to the first, second, and third example to determine the validity of the RO 730. Additionally, or alternatively, the RO 730 may be part of a validated legacy PRACH configuration at the UE 115 or a dedicated SBFD PRACH at the UE 115.

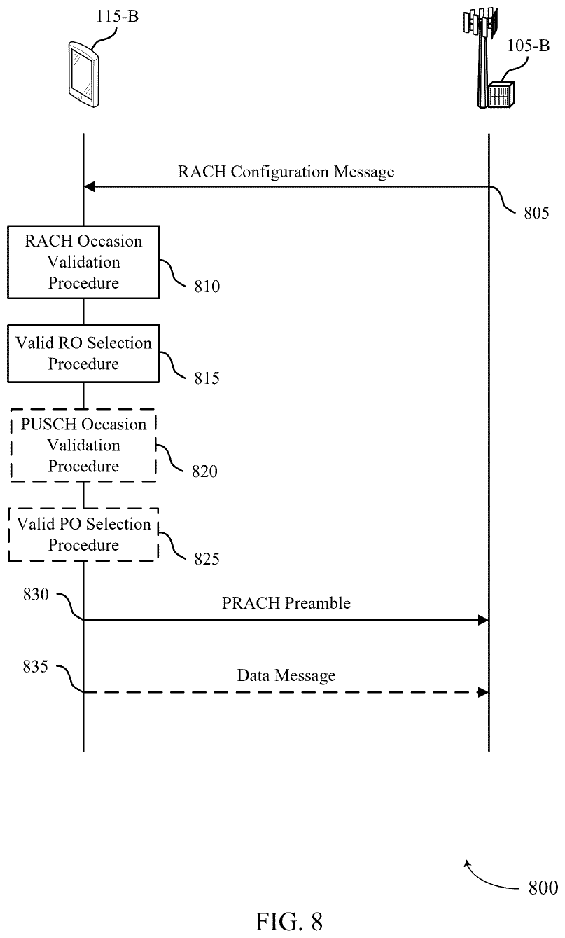

FIG. 8 shows an example of a process flow 800 that supports random access validation across multiple symbol types in accordance with one or more aspects of the present disclosure. In some examples, process flow 800 may implement aspects of wireless communications system 100, wireless communications system 200, transmission occasion validation procedure 300-a through 500-d, and RACH occasion validation procedure 600 and 700. Process flow 800 may include a UE 115-b and a network entity 105-b, as described with reference to FIGS. 1 through 7. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 805, the UE 115-b may receive a configuration message that indicates to the UE 115-b a set of ROs for performance of a random access procedure.

At 810, the UE 115-b may perform a RACH occasion validation procedure (e.g., RACH occasion validation procedure 210, with reference to FIG. 2). For example, the UE 115-b may use a first validity rule that defines a validity of an RO when the RO is associated with a first slot (e.g., PRACH slot) that spans one or more SBFD resources and one or more non-SBFD resources.

In some examples, a valid RO is valid based on the valid RO spanning exclusively the one or more SBFD resources of the first slot or spanning exclusively the one or more non-SBFD resources of the first slot, in accordance with the first validity rule.

In some examples, a valid RO is valid based on the valid RO spanning the one or more SBFD resources and the one or more non-SBFD resources and satisfying one or more conditions. For example, the one or more conditions may include the one or more SBFD resources and the one or more non-SBFD resources being directly adjacent in time, and that the valid RO is associated with a same set of frequency resources, a same spatial configuration, and a same power control parameter across the one or more SBFD resources and the one or more non-SBFD resources, in accordance with the first validity rule.

In some examples, the valid RO may include a set of sequence repetitions. In such examples, the valid RO is valid based on the valid RO including a sequence repetition of the set of sequence repetitions that is aligned with a boundary between the one or more SBFD resources and the one or more non-SBFD resources, in accordance with the first validity rule.

In some examples, the valid RO spans the one or more SBFD resources and the one or more non-SBFD resources and the UE 115-b is scheduled with a second RACH occasion that exclusively spans the one or more non-SBFD resources, where the second RACH occasion may include a TDD-RO. In a first example, the valid RO is valid based on the valid RO spanning one or more first symbols across the one or more non-SBFD resources that are non-overlapping with one or more second symbols associated with the second RO, in accordance with the first validity rule. In a second example, the valid RO is valid based on the valid RO and the second RO each mapping to a same SSB index, in accordance with the first validity rule. In a third example, the valid RO is valid based on the valid RO being associated with a first frequency span and the second RO being associated with a second frequency span, where a frequency distance between the first frequency span and the second frequency span satisfies a threshold, in accordance with the first validity rule.

At 815, the UE 115-b may perform a valid RO selection procedure. For example, the UE 115-b may determine that multiple ROs of the PRACH slot are valid in accordance with performing the RACH occasion validation procedure. As such, the UE 115-b may select a valid RO from the set of RACH occasions based on the first validity rule.

In some examples, the random access procedure may be a type-2 RACH, in which the RACH configuration further configures the UE 115-b with a set of POs. In such examples, the UE 115-b may optionally perform aspects of 820 and 825.

At 820, the UE 115-b may perform a PUSCH occasion validation procedure, where a second validity rule defines a validity of a PO when the PO is associated with a second slot (e.g., a PUSCH slot) that spans one or more second SBFD resources and one or more second non-SBFD resources.

In some examples, the second validity rule defines the validity of a valid PO based on the valid PO spanning exclusively the one or more second SBFD resources of the second slot or spanning exclusively the one or more second non-SBFD resources of the second slot.

In some examples, the second validity rule defines the validity of the valid PO based on the valid PO spanning the one or more second SBFD resources and the one or more second non-SBFD resources of the second slot and satisfying one or more conditions. For example, the one or more conditions may include the one or more second SBFD resources and the one or more second non-SBFD resources being directly adjacent in time, and that the PUSCH occasion is associated with a same set of frequency resources, a same spatial configuration, and a same power control parameter across the one or more second SBFD resources and the one or more second non-SBFD resources of the second slot.

At 825, the UE 115-b may perform a valid PO selection procedure. For example, the UE 115-b may determine that multiple POs of the PUSCH slot are valid in accordance with performing the PUSCH occasion validation procedure. As such, the UE 115-b may select a valid PO from the set of PUSCH occasions based on the second validity rule.

At 830, the UE 115-b may transmit during the valid RO selected in accordance with the first validity rule, a PRACH preamble.

In some cases, the first slot may include a guard period between the one or more SBFD resources and the one or more non-SBFD resources, where the valid RO spans the guard period, the one or more SBFD resources and the one or more non-SBFD resources. In a first example, the UE 115-b may transmit each portion of the PRACH preamble during the valid RO that spans the guard period, the one or more SBFD resources and the one or more non-SBFD resources, where the PRACH preamble is associated with a same set of transmission parameters across the one or more SBFD resources and the one or more non-SBFD resources. In a second example, the UE 115-b may drop a portion of the PRACH preamble that spans the guard period during the valid RO, where the PRACH preamble is associated with a first set of transmission parameters across the one or more SBFD resources and a second set of transmission parameters across the one or more non-SBFD resources. In a third example, the UE 115-b may transmit a first portion of the PRACH preamble associated with resources of the first slot prior to the guard period and drop a second portion of the PRACH preamble associated with resources of the first slot after the guard period. In such a third example, the UE 115-b may determine whether to transmit a third portion of the PRACH preamble associated with resources during the guard period or to drop the third portion of the PRACH preamble. In a fourth example, the UE 115-b may drop a first portion of the PRACH preamble associated with resources of the first slot spanning from a beginning of the first slot to and end of the guard period and transmit a second portion of the PRACH preamble associated with resources of the first slot after to the guard period.

At 835, the UE 115-b may transmit during the valid PO selected in accordance with the second validity rule, a data message.

In some cases, the second slot may include a second guard period between the one or more second SBFD resources and the one or more second non-SBFD resources, where the valid PO spans the second guard period, the one or more second SBFD resources, and the one or more second non-SBFD resources. In a first example, the UE 115-b may transmit each portion of the data message during the valid PO that spans the second guard period, the one or more second SBFD resources, and the one or more second non-SBFD resources, where the data message is associated with a same set of transmission parameters across the one or more second SBFD resources and the one or more second non-SBFD resources. In a second example, the UE 115-b may drop a portion of the data message that spans the second guard period during the valid PO, where the data message is associated with a first set of transmission parameters across the one or more second SBFD resources and a second set of transmission parameters across the one or more second non-SBFD resources. In a third example, the UE 115-b may transmit a first portion of the data message associated with resources of the second slot prior to the second guard period and drop a second portion of the data message associated with resources of the second slot after the second guard period. In such a third example, the UE 115-b may determine whether to transmit a third portion of the data message associated with resources during the second guard period or to drop the third portion of the data message. In a fourth example, the UE 115-b may drop a first portion of the data message associated with resources of the second slot spanning from a beginning of the second slot to and end of the second guard period and transmit a second portion of the data message associated with resources of the second slot after to the second guard period.

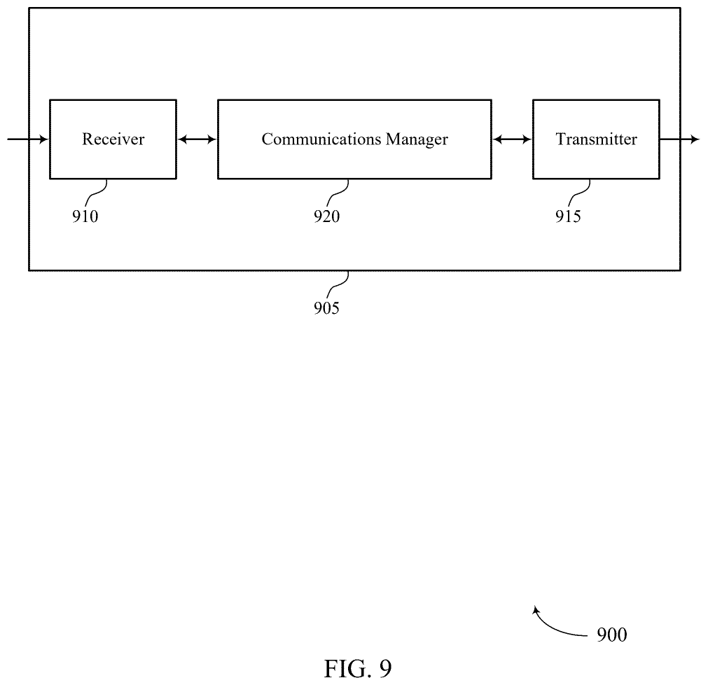

FIG. 9 shows a block diagram 900 of a device 905 that supports random access validation across multiple symbol types in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to random access validation across multiple symbol types). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to random access validation across multiple symbol types). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of random access validation across multiple symbol types as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a configuration message that indicates to the UE a set of multiple ROs for performance of a random access procedure. The communications manager 920 is capable of, configured to, or operable to support a means for selecting a valid RO from the set of multiple ROs based on a first validity rule, where the first validity rule defines a validity of a RO when the RO is associated with a first slot that spans one or more SBFD resources and one or more non-SBFD resources. The communications manager 920 is capable of, configured to, or operable to support a means for transmitting, during the valid RO selected in accordance with the first validity rule, a PRACH preamble.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources.

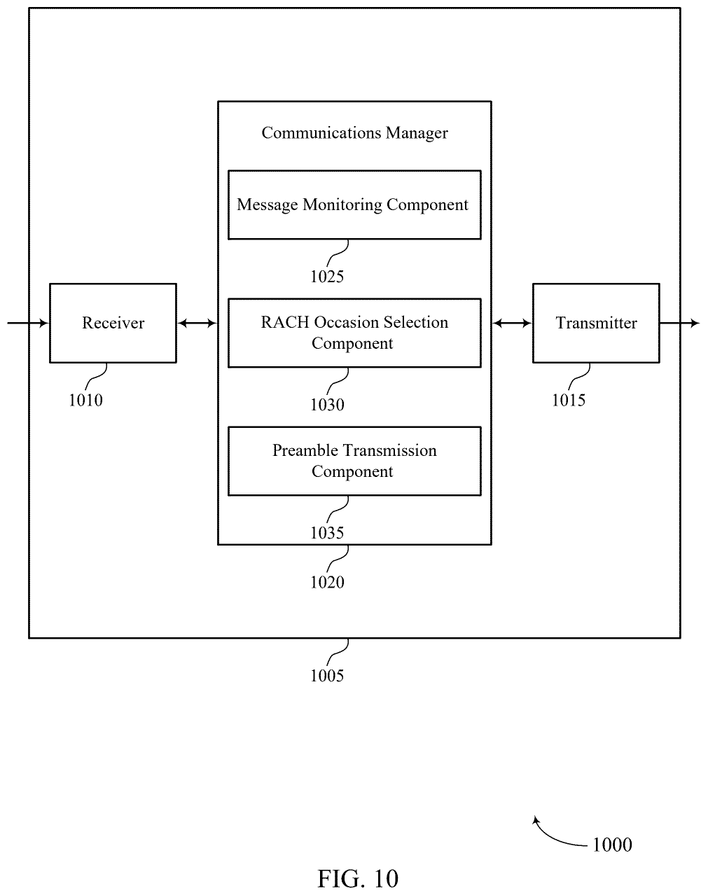

FIG. 10 shows a block diagram 1000 of a device 1005 that supports random access validation across multiple symbol types in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to random access validation across multiple symbol types). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to random access validation across multiple symbol types). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of random access validation across multiple symbol types as described herein. For example, the communications manager 1020 may include a message monitoring component 1025, a RO selection component 1030, a preamble transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The message monitoring component 1025 is capable of, configured to, or operable to support a means for receiving a configuration message that indicates to the UE a set of multiple ROs for performance of a random access procedure. The RO selection component 1030 is capable of, configured to, or operable to support a means for selecting a valid RO from the set of multiple ROs based on a first validity rule, where the first validity rule defines a validity of a RO when the RO is associated with a first slot that spans one or more SBFD resources and one or more non-SBFD resources. The preamble transmission component 1035 is capable of, configured to, or operable to support a means for transmitting, during the valid RO selected in accordance with the first validity rule, a PRACH preamble.

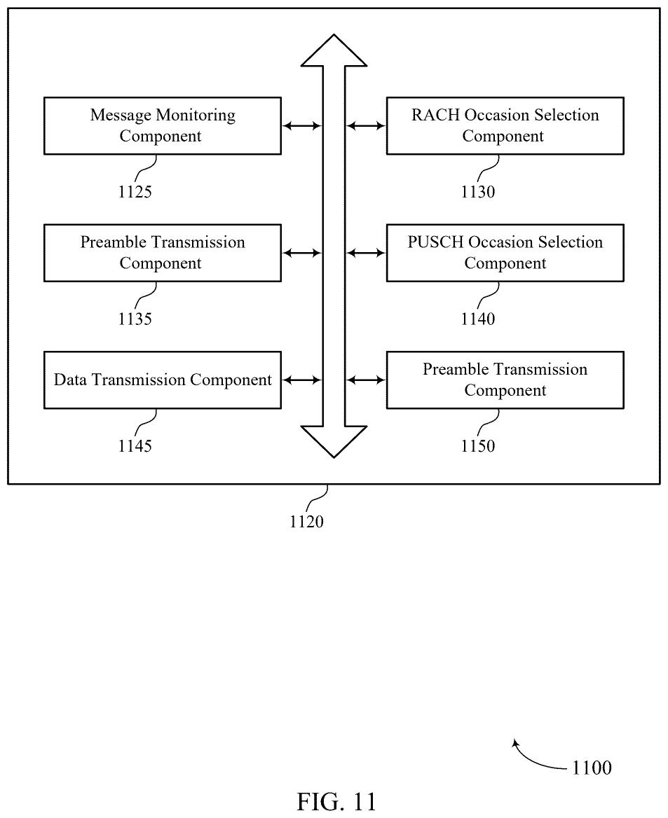

FIG. 11 shows a block diagram 1100 of a communications manager 1120 that supports random access validation across multiple symbol types in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of random access validation across multiple symbol types as described herein. For example, the communications manager 1120 may include a message monitoring component 1125, a RO selection component 1130, a preamble transmission component 1135, an PUSCH occasion selection component 1140, a data transmission component 1145, a preamble transmission component 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The message monitoring component 1125 is capable of, configured to, or operable to support a means for receiving a configuration message that indicates to the UE a set of multiple ROs for performance of a random access procedure. The RO selection component 1130 is capable of, configured to, or operable to support a means for selecting a valid RO from the set of multiple ROs based on a first validity rule, where the first validity rule defines a validity of a RO when the RO is associated with a first slot that spans one or more SBFD resources and one or more non-SBFD resources. The preamble transmission component 1135 is capable of, configured to, or operable to support a means for transmitting, during the valid RO selected in accordance with the first validity rule, a PRACH preamble.

In some examples, the valid RO is valid based on the valid RO spanning exclusively the one or more SBFD resources of the first slot or spanning exclusively the one or more non-SBFD resources of the first slot, in accordance with the first validity rule.

In some examples, the valid RO is valid based on the valid RO spanning the one or more SBFD resources and the one or more non-SBFD resources. In some examples, the one or more SBFD resources and the one or more non-SBFD resources are directly adjacent in time. In some examples, the valid RO is associated with a same set of multiple frequency resources, a same spatial configuration, and a same power control parameter across the one or more SBFD resources and the one or more non-SBFD resources, in accordance with the first validity rule.

In some examples, the first slot includes a guard period between the one or more SBFD resources and the one or more non-SBFD resources and the valid RO spans the guard period, the one or more SBFD resources and the one or more non-SBFD resources.

In some examples, the preamble transmission component 1150 is capable of, configured to, or operable to support a means for transmitting each portion of the PRACH preamble during the valid RO that spans the guard period, the one or more SBFD resources and the one or more non-SBFD resources, where the PRACH preamble is associated with a same set of transmission parameters across the one or more SBFD resources and the one or more non-SBFD resources.

In some examples, the preamble transmission component 1150 is capable of, configured to, or operable to support a means for dropping a portion of the PRACH preamble that spans the guard period during the valid RO, where the PRACH preamble is associated with a first set of transmission parameters across the one or more SBFD resources and a second set of transmission parameters across the one or more non-SBFD resources.

In some examples, the preamble transmission component 1150 is capable of, configured to, or operable to support a means for transmitting a first portion of the PRACH preamble associated with the one or more SBFD resources of the first slot prior to the guard period. In some examples, the preamble transmission component 1150 is capable of, configured to, or operable to support a means for dropping a second portion of the PRACH preamble associated with the one or more non-SBFD resources of the first slot after the guard period.

In some examples, the preamble transmission component 1150 is capable of, configured to, or operable to support a means for transmitting a third portion of the PRACH preamble associated with resources during the guard period.

In some examples, the preamble transmission component 1150 is capable of, configured to, or operable to support a means for dropping a first portion of the PRACH preamble associated with the one or more SBFD resources of the first slot spanning from a beginning of the first slot to and end of the guard period. In some examples, the preamble transmission component 1150 is capable of, configured to, or operable to support a means for transmitting a second portion of the PRACH preamble associated with the one or more non-SBFD resources of the first slot after to the guard period.

In some examples, the valid RO includes a set of multiple sequence repetitions. In some examples, the valid RO is valid based on the valid RO including a sequence repetition of the set of multiple sequence repetitions that is aligned with a boundary between the one or more SBFD resources and the one or more non-SBFD resources, in accordance with the first validity rule.

In some examples, the valid RO spans the one or more SBFD resources and the one or more non-SBFD resources. In some examples, the UE is configured with a second RO that exclusively spans the one or more non-SBFD resources, the second RO including a time division duplex RO.

In some examples, the valid RO is valid based on the valid RO spanning one or more first symbols across the one or more non-SBFD resources that are non-overlapping with one or more second symbols associated with the second RO, in accordance with the first validity rule.

In some examples, the valid RO is valid based on the valid RO and the second RO each mapping to a same synchronization signal block index, in accordance with the first validity rule.

In some examples, the valid RO is valid based on the valid RO being associated with a first frequency span and the second RO being associated with a second frequency span. In some examples, a frequency distance between the first frequency span and the second frequency span satisfies a threshold, in accordance with the first validity rule.

In some examples, the random access procedure is a two-step random access procedure, and the PUSCH occasion selection component 1140 is capable of, configured to, or operable to support a means for selecting a valid PUSCH occasion from a set of multiple PUSCH occasions based on a second validity rule, where the second validity rule defines a validity of a PUSCH occasion when the PUSCH occasion is associated with a second slot that spans one or more second SBFD resources and one or more second non-SBFD resources. In some examples, the random access procedure is a two-step random access procedure, and the data transmission component 1145 is capable of, configured to, or operable to support a means for transmitting, during the valid PUSCH occasion selected in accordance with the second validity rule, a data message.

In some examples, the second validity rule defines the validity of the valid PUSCH occasion based on the valid PUSCH occasion spanning exclusively the one or more second SBFD resources of the second slot or spanning exclusively the one or more second non-SBFD resources of the second slot.

In some examples, the second validity rule defines the validity of the valid PUSCH occasion based on the valid PUSCH occasion spanning the one or more second SBFD resources and the one or more second non-SBFD resources of the second slot. In some examples, the one or more second SBFD resources and the one or more second non-SBFD resources are directly adjacent in time. In some examples, the PUSCH occasion is associated with a same set of multiple frequency resources, a same spatial configuration, and a same power control parameter across the one or more second SBFD resources and the one or more second non-SBFD resources of the second slot.

In some examples, the second slot includes a second guard period between the one or more second SBFD resources and the one or more second non-SBFD resources and the valid PUSCH occasion spans the second guard period, the one or more second SBFD resources and the one or more second non-SBFD resources.

In some examples, the data transmission component 1145 is capable of, configured to, or operable to support a means for transmitting each portion of the data message during the valid PUSCH occasion that spans the second guard period, the one or more second SBFD resources and the one or more second non-SBFD resources, where the data message is associated with a same set of transmission parameters across the one or more second SBFD resources and the one or more second non-SBFD resources.

In some examples, the data transmission component 1145 is capable of, configured to, or operable to support a means for dropping a portion of the data message that spans the second guard period during the valid PUSCH occasion, where the data message is associated with a first set of transmission parameters across the one or more second SBFD resources and a second set of transmission parameters across the one or more second non-SBFD resources.

In some examples, the data transmission component 1145 is capable of, configured to, or operable to support a means for transmitting a first portion of the data message associated with the one or more second SBFD resources of the second slot prior to the second guard period. In some examples, the data transmission component 1145 is capable of, configured to, or operable to support a means for dropping a second portion of the data message associated with the one or more second non-SBFD resources of the second slot after the second guard period.

In some examples, the data transmission component 1145 is capable of, configured to, or operable to support a means for transmitting a third portion of the data message associated with resources during the second guard period.

In some examples, the data transmission component 1145 is capable of, configured to, or operable to support a means for dropping a first portion of the data message associated with the one or more second SBFD resources of the second slot spanning from a beginning of the second slot to and end of the second guard period. In some examples, the data transmission component 1145 is capable of, configured to, or operable to support a means for transmitting a second portion of the data message associated with the one or more second non-SBFD resources of the second slot after to the second guard period.

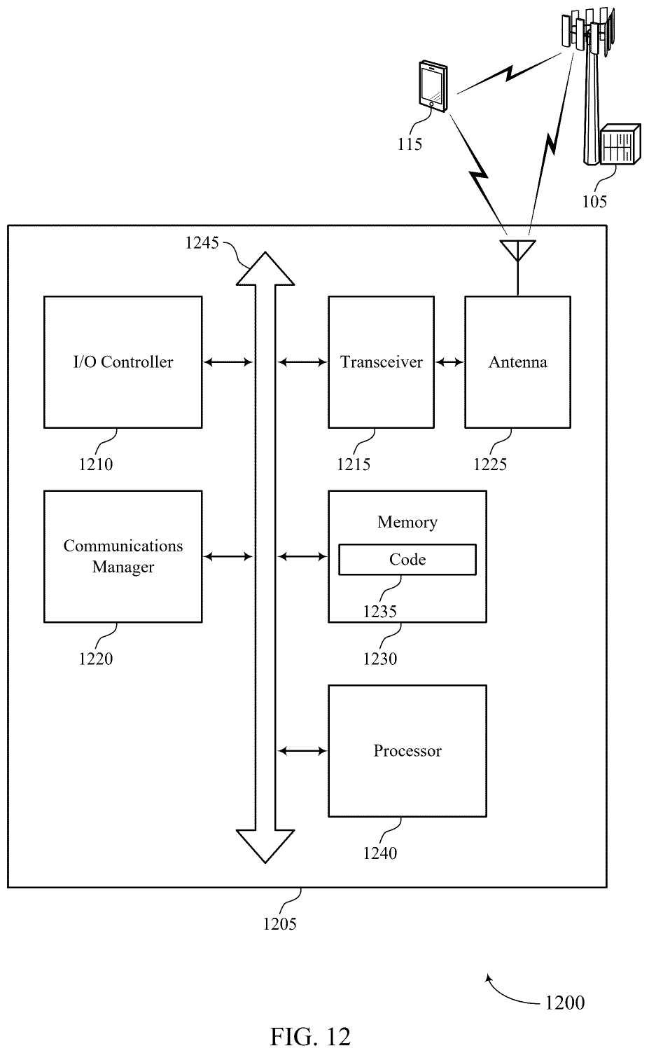

FIG. 12 shows a diagram of a system 1200 including a device 1205 that supports random access validation across multiple symbol types in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting random access validation across multiple symbol types). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a configuration message that indicates to the UE a set of multiple ROs for performance of a random access procedure. The communications manager 1220 is capable of, configured to, or operable to support a means for selecting a valid RO from the set of multiple ROs based on a first validity rule, where the first validity rule defines a validity of a RO when the RO is associated with a first slot that spans one or more SBFD resources and one or more non-SBFD resources. The communications manager 1220 is capable of, configured to, or operable to support a means for transmitting, during the valid RO selected in accordance with the first validity rule, a PRACH preamble.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of random access validation across multiple symbol types as described herein, or the at least one processor 1240 and the at least one memory 1230 may be otherwise configured to, individually or collectively, perform or support such operations.

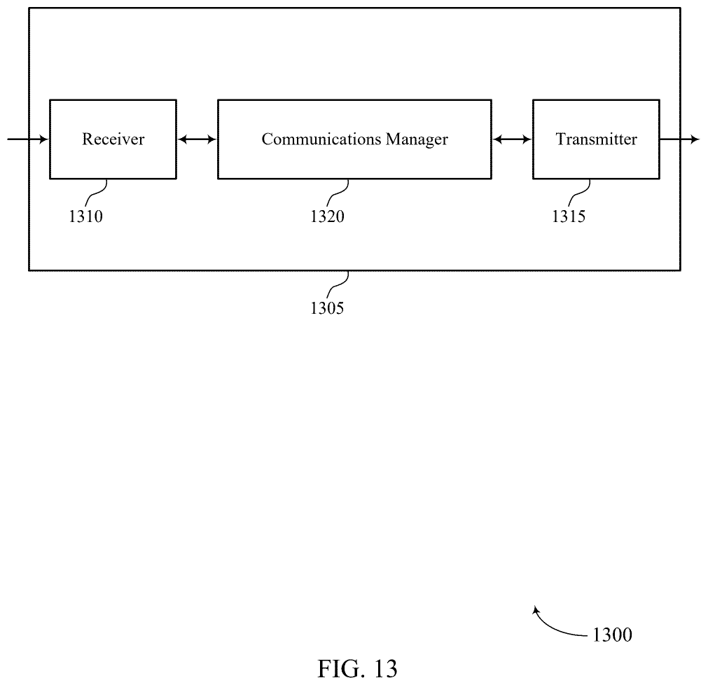

FIG. 13 shows a block diagram 1300 of a device 1305 that supports random access validation across multiple symbol types in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of random access validation across multiple symbol types as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting a configuration message that indicates to a UE a set of multiple ROs for performance of a random access procedure. The communications manager 1320 is capable of, configured to, or operable to support a means for receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, more efficient utilization of communication resources.

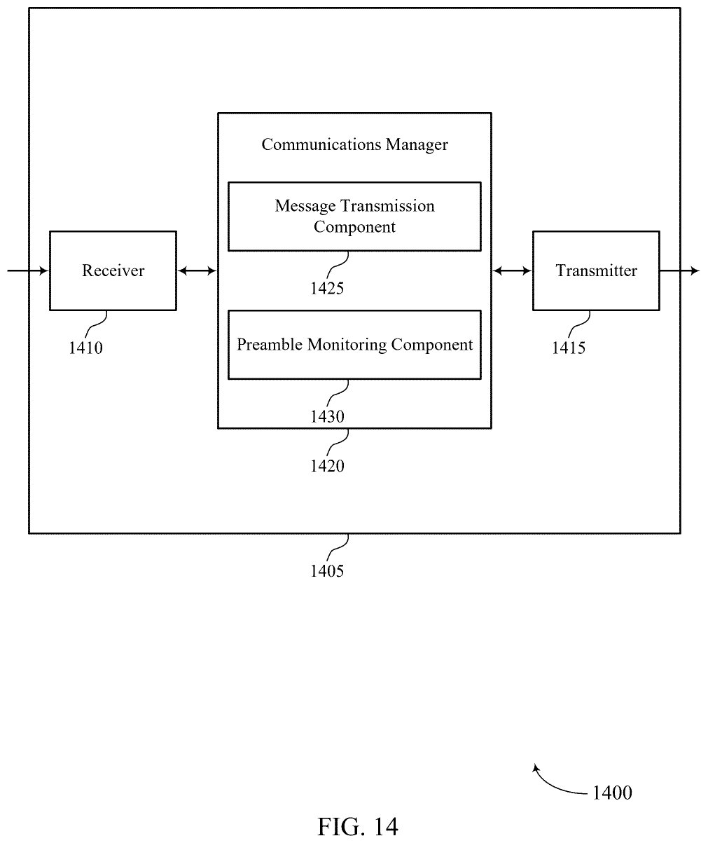

FIG. 14 shows a block diagram 1400 of a device 1405 that supports random access validation across multiple symbol types in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of random access validation across multiple symbol types as described herein. For example, the communications manager 1420 may include a message transmission component 1425 a preamble monitoring component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The message transmission component 1425 is capable of, configured to, or operable to support a means for transmitting a configuration message that indicates to a UE a set of multiple ROs for performance of a random access procedure. The preamble monitoring component 1430 is capable of, configured to, or operable to support a means for receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

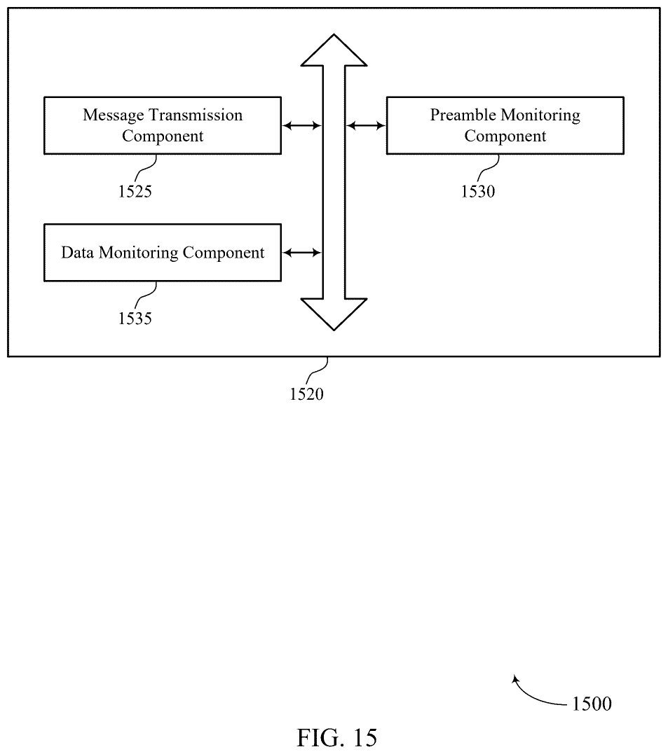

FIG. 15 shows a block diagram 1500 of a communications manager 1520 that supports random access validation across multiple symbol types in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of random access validation across multiple symbol types as described herein. For example, the communications manager 1520 may include a message transmission component 1525, a preamble monitoring component 1530, a data monitoring component 1535, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The message transmission component 1525 is capable of, configured to, or operable to support a means for transmitting a configuration message that indicates to a UE a set of multiple ROs for performance of a random access procedure. The preamble monitoring component 1530 is capable of, configured to, or operable to support a means for receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

In some examples, the valid RO is valid based on the valid RO spanning exclusively the one or more SBFD resources of the first slot or spanning exclusively the one or more non-SBFD resources of the first slot, in accordance with the first validity rule.

In some examples, the valid RO is valid based on the valid RO spanning the one or more SBFD resources and the one or more non-SBFD resources. In some examples, the one or more SBFD resources and the one or more non-SBFD resources are directly adjacent in time. In some examples, the valid RO is associated with a same set of multiple frequency resources, a same spatial configuration, and a same power control parameter across the one or more SBFD resources and the one or more non-SBFD resources, in accordance with the first validity rule.

In some examples, the first slot includes a guard period between the one or more SBFD resources and the one or more non-SBFD resources and the valid RO spans the guard period, the one or more SBFD resources and the one or more non-SBFD resources.

In some examples, the preamble monitoring component 1530 is capable of, configured to, or operable to support a means for receiving each portion of the PRACH preamble during the valid RO that spans the guard period, the one or more SBFD resources and the one or more non-SBFD resources, where the PRACH preamble is associated with a same set of transmission parameters across the one or more SBFD resources and the one or more non-SBFD resources.

In some examples, the preamble monitoring component 1530 is capable of, configured to, or operable to support a means for receiving a first portion of the PRACH preamble associated with the one or more SBFD resources of the first slot prior to the guard period.

In some examples, the preamble monitoring component 1530 is capable of, configured to, or operable to support a means for receiving a second portion of the PRACH preamble associated with resources during the guard period.

In some examples, the preamble monitoring component 1530 is capable of, configured to, or operable to support a means for receiving a first portion of the PRACH preamble associated with the one or more non-SBFD resources of the first slot after to the guard period.

In some examples, the valid RO includes a set of multiple sequence repetitions. In some examples, the valid RO is valid based on the valid RO including a sequence repetition of the set of multiple sequence repetitions that is aligned with a boundary between the one or more SBFD resources and the one or more non-SBFD resources, in accordance with the first validity rule.

In some examples, the valid RO spans the one or more SBFD resources and the one or more non-SBFD resources. In some examples, the UE is scheduled with a second RO that exclusively spans the one or more non-SBFD resources, the second RO including a time division duplex RO.

In some examples, the valid RO is valid based on the valid RO spanning one or more first symbols across the one or more non-SBFD resources that are non-overlapping with one or more second symbols associated with the second RO, in accordance with the first validity rule.

In some examples, the valid RO is valid based on the valid RO and the second RO each mapping to a same synchronization signal block index, in accordance with the first validity rule.

In some examples, the valid RO is valid based on the valid RO being associated with a first frequency span and the second RO being associated with a second frequency span. In some examples, a frequency distance between the first frequency span and the second frequency span satisfies a threshold, in accordance with the first validity rule.

In some examples, the random access procedure is a two-step random access procedure, and the data monitoring component 1535 is capable of, configured to, or operable to support a means for receiving, during a valid PUSCH occasion of a set of multiple PUSCH occasions, a data message, where the valid PUSCH occasion is based on a second validity rule, where the second validity rule defines a validity of a PUSCH occasion when the PUSCH occasion is associated with a second slot that spans one or more second SBFD resources and one or more second non-SBFD resources.

In some examples, the second validity rule defines the validity of the valid PUSCH occasion based on the valid PUSCH occasion spanning exclusively the one or more second SBFD resources of the second slot or spanning exclusively the one or more second non-SBFD resources of the second slot.

In some examples, the second validity rule defines the validity of the valid PUSCH occasion based on the valid PUSCH occasion spanning the one or more second SBFD resources and the one or more second non-SBFD resources of the second slot. In some examples, the one or more second SBFD resources and the one or more second non-SBFD resources are directly adjacent in time. In some examples, the PUSCH occasion is associated with a same set of multiple frequency resources, a same spatial configuration, and a same power control parameter across the one or more second SBFD resources and the one or more second non-SBFD resources of the second slot.

In some examples, the second slot includes a second guard period between the one or more second SBFD resources and the one or more second non-SBFD resources and the valid PUSCH occasion spans the second guard period, the one or more second SBFD resources and the one or more second non-SBFD resources.

In some examples, the data monitoring component 1535 is capable of, configured to, or operable to support a means for receiving each portion of the data message during the valid PUSCH occasion that spans the second guard period, the one or more second SBFD resources and the one or more second non-SBFD resources, where the data message is associated with a same set of transmission parameters across the one or more second SBFD resources and the one or more second non-SBFD resources.

In some examples, the data monitoring component 1535 is capable of, configured to, or operable to support a means for receiving a first portion of the data message associated with the one or more second SBFD resources of the second slot prior to the second guard period.

In some examples, the data monitoring component 1535 is capable of, configured to, or operable to support a means for receiving a second portion of the data message associated with resources during the second guard period.

In some examples, the data monitoring component 1535 is capable of, configured to, or operable to support a means for receiving a first portion of the data message associated with the one or more second non-SBFD resources of the second slot after to the second guard period.

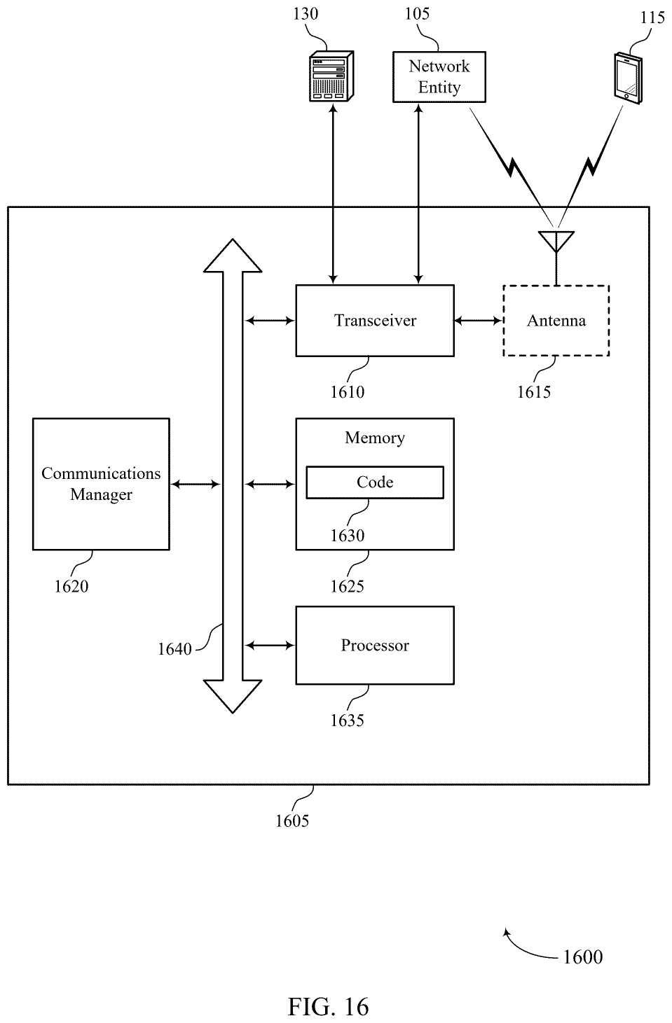

FIG. 16 shows a diagram of a system 1600 including a device 1605 that supports random access validation across multiple symbol types in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting random access validation across multiple symbol types). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting a configuration message that indicates to a UE a set of multiple ROs for performance of a random access procedure. The communications manager 1620 is capable of, configured to, or operable to support a means for receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of random access validation across multiple symbol types as described herein, or the at least one processor 1635 and the at least one memory 1625 may be otherwise configured to, individually or collectively, perform or support such operations.

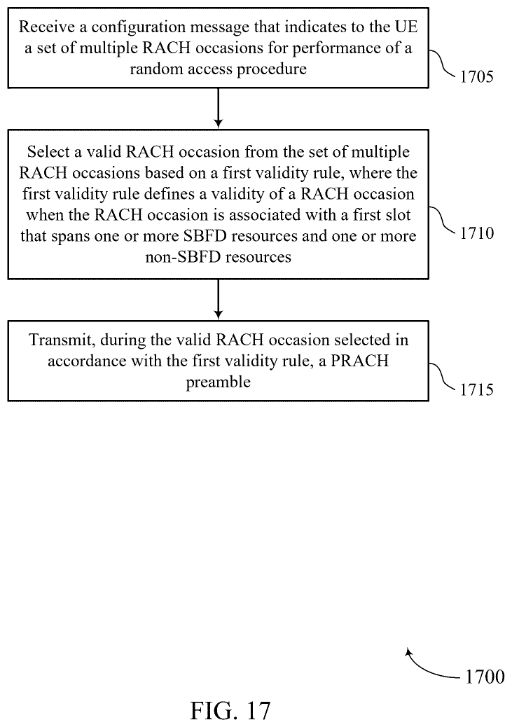

FIG. 17 shows a flowchart illustrating a method 1700 that supports random access validation across multiple symbol types in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a configuration message that indicates to the UE a set of multiple ROs for performance of a random access procedure. The operations of 1705 may be performed in accordance with examples as disclosed herein. In some examples, aspects of the operations of 1705 may be performed by a message monitoring component 1125 as described with reference to FIG. 11.

At 1710, the method may include selecting a valid RO from the set of multiple ROs based on a first validity rule, where the first validity rule defines a validity of a RO when the RO is associated with a first slot that spans one or more SBFD resources and one or more non-SBFD resources. The operations of 1710 may be performed in accordance with examples as disclosed herein. In some examples, aspects of the operations of 1710 may be performed by a RO selection component 1130 as described with reference to FIG. 11.

At 1715, the method may include transmitting, during the valid RO selected in accordance with the first validity rule, a PRACH preamble. The operations of 1715 may be performed in accordance with examples as disclosed herein. In some examples, aspects of the operations of 1715 may be performed by a preamble transmission component 1135 as described with reference to FIG. 11.

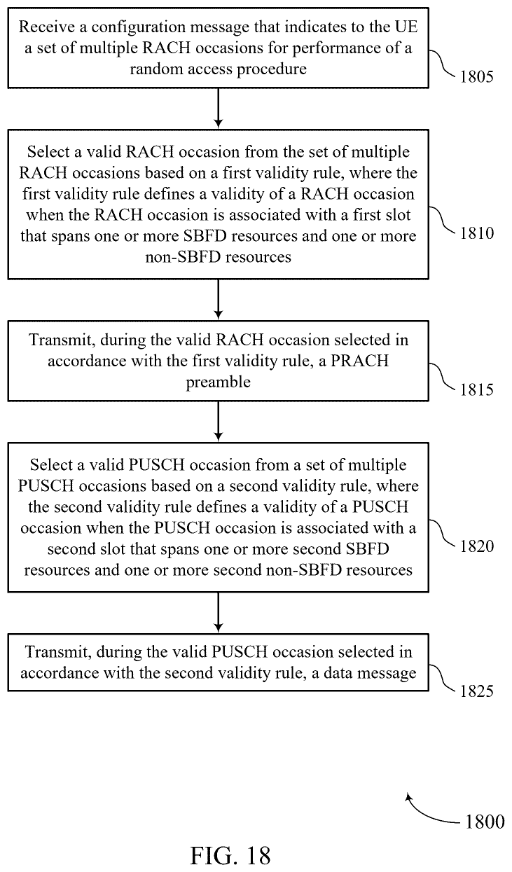

FIG. 18 shows a flowchart illustrating a method 1800 that supports random access validation across multiple symbol types in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a configuration message that indicates to the UE a set of multiple ROs for performance of a random access procedure. The operations of 1805 may be performed in accordance with examples as disclosed herein. In some examples, aspects of the operations of 1805 may be performed by a message monitoring component 1125 as described with reference to FIG. 11.

At 1810, the method may include selecting a valid RO from the set of multiple ROs based on a first validity rule, where the first validity rule defines a validity of a RO when the RO is associated with a first slot that spans one or more SBFD resources and one or more non-SBFD resources. The operations of 1810 may be performed in accordance with examples as disclosed herein. In some examples, aspects of the operations of 1810 may be performed by a RO selection component 1130 as described with reference to FIG. 11.

At 1815, the method may include transmitting, during the valid RO selected in accordance with the first validity rule, a PRACH preamble. The operations of 1815 may be performed in accordance with examples as disclosed herein. In some examples, aspects of the operations of 1815 may be performed by a preamble transmission component 1135 as described with reference to FIG. 11.

At 1820, the method may include selecting a valid PUSCH occasion from a set of multiple PUSCH occasions based on a second validity rule, where the second validity rule defines a validity of a PUSCH occasion when the PUSCH occasion is associated with a second slot that spans one or more second SBFD resources and one or more second non-SBFD resources. The operations of 1820 may be performed in accordance with examples as disclosed herein. In some examples, aspects of the operations of 1820 may be performed by an PUSCH occasion selection component 1140 as described with reference to FIG. 11.

At 1825, the method may include transmitting, during the valid PUSCH occasion selected in accordance with the second validity rule, a data message. The operations of 1825 may be performed in accordance with examples as disclosed herein. In some examples, aspects of the operations of 1825 may be performed by a data transmission component 1145 as described with reference to FIG. 11.

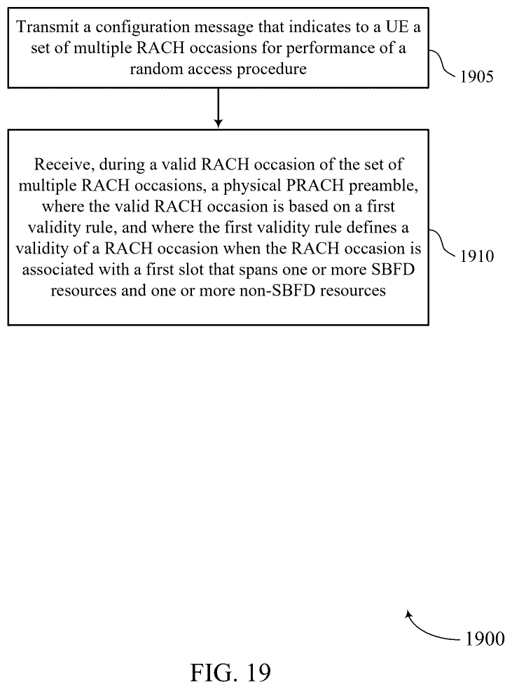

FIG. 19 shows a flowchart illustrating a method 1900 that supports random access validation across multiple symbol types in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a configuration message that indicates to a UE a set of multiple ROs for performance of a random access procedure. The operations of 1905 may be performed in accordance with examples as disclosed herein. In some examples, aspects of the operations of 1905 may be performed by a message transmission component 1525 as described with reference to FIG. 15.

At 1910, the method may include receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources. The operations of 1910 may be performed in accordance with examples as disclosed herein. In some examples, aspects of the operations of 1910 may be performed by a preamble monitoring component 1530 as described with reference to FIG. 15.

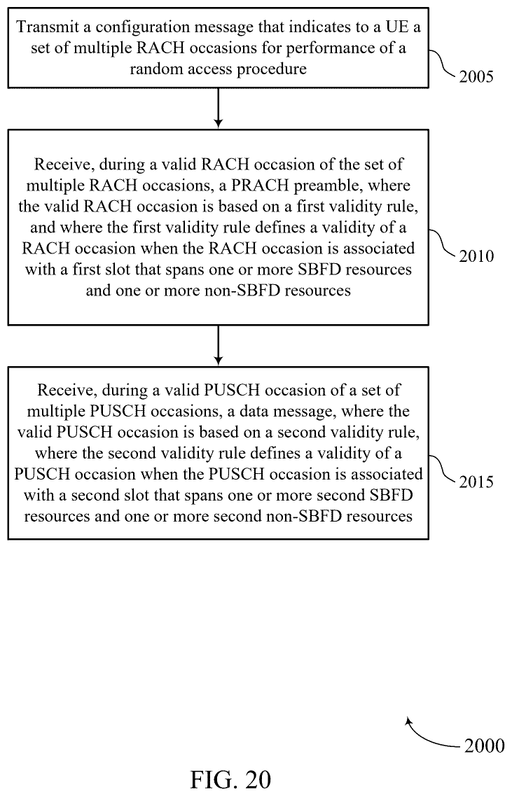

FIG. 20 shows a flowchart illustrating a method 2000 that supports random access validation across multiple symbol types in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a configuration message that indicates to a UE a set of multiple ROs for performance of a random access procedure. The operations of 2005 may be performed in accordance with examples as disclosed herein. In some examples, aspects of the operations of 2005 may be performed by a message transmission component 1525 as described with reference to FIG. 15.

At 2010, the method may include receiving, during a valid RO of the set of multiple ROs, a PRACH preamble, where the valid RO is based on a first validity rule, and where the first validity rule defines a validity of a RO when the RO is associated with a first slot that spans one or more SBFD resources and one or more non-SBFD resources. The operations of 2010 may be performed in accordance with examples as disclosed herein. In some examples, aspects of the operations of 2010 may be performed by a preamble monitoring component 1530 as described with reference to FIG. 15.

At 2015, the method may include receiving, during a valid PUSCH occasion of a set of multiple PUSCH occasions, a data message, where the valid PUSCH occasion is based on a second validity rule, where the second validity rule defines a validity of a PUSCH occasion when the PUSCH occasion is associated with a second slot that spans one or more second SBFD resources and one or more second non-SBFD resources. The operations of 2015 may be performed in accordance with examples as disclosed herein. In some examples, aspects of the operations of 2015 may be performed by a data monitoring component 1535 as described with reference to FIG. 15.

The following provides an overview of aspects of the present disclosure:

Aspect 1: A method for wireless communications, at a UE, comprising: receiving a configuration message that indicates to the UE a plurality of ROs for performance of a random access procedure; selecting a valid RO from the plurality of ROs based at least in part on a first validity rule, wherein the first validity rule defines a validity of a RO when the RO is associated with a first slot that spans one or more SBFD resources and one or more non-SBFD resources; and transmitting, during the valid RO selected in accordance with the first validity rule, a PRACH preamble.

Aspect 2: The method of aspect 1, wherein the valid RO is valid based at least in part on the valid RO spanning exclusively the one or more SBFD resources of the first slot or spanning exclusively the one or more non-SBFD resources of the first slot, in accordance with the first validity rule.

Aspect 3: The method of any of aspects 1 through 2, wherein the valid RO is valid based at least in part on the valid RO spanning the one or more SBFD resources and the one or more non-SBFD resources, the one or more SBFD resources and the one or more non-SBFD resources are directly adjacent in time, and the valid RO is associated with a same plurality of frequency resources, a same spatial configuration, and a same power control parameter across the one or more SBFD resources and the one or more non-SBFD resources, in accordance with the first validity rule.

Aspect 4: The method of any of aspects 1 through 3, wherein the first slot comprises a guard period between the one or more SBFD resources and the one or more non-SBFD resources and the valid RO spans the guard period, the one or more SBFD resources and the one or more non-SBFD resources.

Aspect 5: The method of aspect 4, further comprising: transmitting each portion of the PRACH preamble during the valid RO that spans the guard period, the one or more SBFD resources and the one or more non-SBFD resources, wherein the PRACH preamble is associated with a same set of transmission parameters across the one or more SBFD resources and the one or more non-SBFD resources.

Aspect 6: The method of any of aspects 4 through 5, further comprising: dropping a portion of the PRACH preamble that spans the guard period during the valid RO, wherein the PRACH preamble is associated with a first set of transmission parameters across the one or more SBFD resources and a second set of transmission parameters across the one or more non-SBFD resources.

Aspect 7: The method of any of aspects 4 through 6, further comprising: transmitting a first portion of the PRACH preamble associated with the one or more SBFD resources of the first slot prior to the guard period; and dropping a second portion of the PRACH preamble associated with the one or more non-SBFD resources of the first slot after the guard period.

Aspect 8: The method of aspect 7, further comprising: transmitting a third portion of the PRACH preamble associated with resources during the guard period.

Aspect 9: The method of any of aspects 4 through 8, further comprising: dropping a first portion of the PRACH preamble associated with the one or more SBFD resources of the first slot spanning from a beginning of the first slot to and end of the guard period; and transmitting a second portion of the PRACH preamble associated with the one or more non-SBFD resources of the first slot after to the guard period.

Aspect 10: The method of any of aspects 1 through 9, wherein the valid RO comprises a plurality of sequence repetitions, and the valid RO is valid based at least in part on the valid RO comprising a sequence repetition of the plurality of sequence repetitions that is aligned with a boundary between the one or more SBFD resources and the one or more non-SBFD resources, in accordance with the first validity rule.

Aspect 11: The method of any of aspects 1 through 10, wherein the valid RO spans the one or more SBFD resources and the one or more non-SBFD resources, and the UE is configured with a second RO that exclusively spans the one or more non-SBFD resources, the second RO comprising a time division duplex RO.

Aspect 12: The method of aspect 11, wherein the valid RO is valid based at least in part on the valid RO spanning one or more first symbols across the one or more non-SBFD resources that are non-overlapping with one or more second symbols associated with the second RO, in accordance with the first validity rule.

Aspect 13: The method of any of aspects 11 through 12, wherein the valid RO is valid based at least in part on the valid RO and the second RO each mapping to a same synchronization signal block index, in accordance with the first validity rule.

Aspect 14: The method of any of aspects 11 through 13, wherein the valid RO is valid based at least in part on the valid RO being associated with a first frequency span and the second RO being associated with a second frequency span, and a frequency distance between the first frequency span and the second frequency span satisfies a threshold, in accordance with the first validity rule.

Aspect 15: The method of any of aspects 1 through 14, wherein the random access procedure is a two-step random access procedure, the method further comprising: selecting a valid PUSCH occasion from a plurality of PUSCH occasions based at least in part on a second validity rule, wherein the second validity rule defines a validity of a PUSCH occasion when the PUSCH occasion is associated with a second slot that spans one or more second SBFD resources and one or more second non-SBFD resources; and transmitting, during the valid PUSCH occasion selected in accordance with the second validity rule, a data message.

Aspect 16: The method of aspect 15, wherein the second validity rule defines the validity of the valid PUSCH occasion based at least in part on the valid PUSCH occasion spanning exclusively the one or more second SBFD resources of the second slot or spanning exclusively the one or more second non-SBFD resources of the second slot.

Aspect 17: The method of any of aspects 15 through 16, wherein the second validity rule defines the validity of the valid PUSCH occasion based at least in part on the valid PUSCH occasion spanning the one or more second SBFD resources and the one or more second non-SBFD resources of the second slot, the one or more second SBFD resources and the one or more second non-SBFD resources are directly adjacent in time, and the PUSCH occasion is associated with a same plurality of frequency resources, a same spatial configuration, and a same power control parameter across the one or more second SBFD resources and the one or more second non-SBFD resources of the second slot.

Aspect 18: The method of any of aspects 15 through 17, wherein the second slot comprises a second guard period between the one or more second SBFD resources and the one or more second non-SBFD resources and the valid PUSCH occasion spans the second guard period, the one or more second SBFD resources and the one or more second non-SBFD resources.

Aspect 19: The method of aspect 18, further comprising: transmitting each portion of the data message during the valid PUSCH occasion that spans the second guard period, the one or more second SBFD resources and the one or more second non-SBFD resources, wherein the data message is associated with a same set of transmission parameters across the one or more second SBFD resources and the one or more second non-SBFD resources.

Aspect 20: The method of any of aspects 18 through 19, further comprising: dropping a portion of the data message that spans the second guard period during the valid PUSCH occasion, wherein the data message is associated with a first set of transmission parameters across the one or more second SBFD resources and a second set of transmission parameters across the one or more second non-SBFD resources.

Aspect 21: The method of any of aspects 18 through 20, further comprising: transmitting a first portion of the data message associated with the one or more second SBFD resources of the second slot prior to the second guard period; and dropping a second portion of the data message associated with the one or more second non-SBFD resources of the second slot after the second guard period.

Aspect 22: The method of aspect 21, further comprising: transmitting a third portion of the data message associated with resources during the second guard period.

Aspect 23: The method of any of aspects 18 through 22, further comprising: dropping a first portion of the data message associated with the one or more second SBFD resources of the second slot spanning from a beginning of the second slot to and end of the second guard period; and transmitting a second portion of the data message associated with the one or more second non-SBFD resources of the second slot after to the second guard period.

Aspect 24: A method for wireless communications, at a network entity, comprising: transmitting a configuration message that indicates to a UE a plurality of ROs for performance of a random access procedure; and receiving, during a valid RO of the plurality of ROs, a PRACH preamble, wherein the valid RO is based at least in part on a first validity rule, and wherein the first validity rule defines a validity of a RO when the RO is associated with a first slot that spans one or more SBFD resources and one or more non-SBFD resources.

Aspect 25: The method of aspect 24, wherein the valid RO is valid based at least in part on the valid RO spanning exclusively the one or more SBFD resources of the first slot or spanning exclusively the one or more non-SBFD resources of the first slot, in accordance with the first validity rule.

Aspect 26: The method of any of aspects 24 through 25, wherein the valid RO is valid based at least in part on the valid RO spanning the one or more SBFD resources and the one or more non-SBFD resources, the one or more SBFD resources and the one or more non-SBFD resources are directly adjacent in time, and the valid RO is associated with a same plurality of frequency resources, a same spatial configuration, and a same power control parameter across the one or more SBFD resources and the one or more non-SBFD resources, in accordance with the first validity rule.

Aspect 27: The method of any of aspects 24 through 26, wherein the first slot comprises a guard period between the one or more SBFD resources and the one or more non-SBFD resources and the valid RO spans the guard period, the one or more SBFD resources and the one or more non-SBFD resources.

Aspect 28: The method of aspect 27, further comprising: receiving each portion of the PRACH preamble during the valid RO that spans the guard period, the one or more SBFD resources and the one or more non-SBFD resources, wherein the PRACH preamble is associated with a same set of transmission parameters across the one or more SBFD resources and the one or more non-SBFD resources.

Aspect 29: The method of any of aspects 27 through 28, further comprising: receiving a first portion of the PRACH preamble associated with the one or more SBFD resources of the first slot prior to the guard period.

Aspect 30: The method of aspect 29, further comprising: receiving a second portion of the PRACH preamble associated with resources during the guard period.

Aspect 31: The method of any of aspects 27 through 30, further comprising: receiving a first portion of the PRACH preamble associated with the one or more non-SBFD resources of the first slot after to the guard period.

Aspect 32: The method of any of aspects 24 through 31, wherein the valid RO comprises a plurality of sequence repetitions, and the valid RO is valid based at least in part on the valid RO comprising a sequence repetition of the plurality of sequence repetitions that is aligned with a boundary between the one or more SBFD resources and the one or more non-SBFD resources, in accordance with the first validity rule.

Aspect 33: The method of any of aspects 24 through 32, wherein the valid RO spans the one or more SBFD resources and the one or more non-SBFD resources, and the UE is scheduled with a second RO that exclusively spans the one or more non-SBFD resources, the second RO comprising a time division duplex RO.

Aspect 34: The method of aspect 33, wherein the valid RO is valid based at least in part on the valid RO spanning one or more first symbols across the one or more non-SBFD resources that are non-overlapping with one or more second symbols associated with the second RO, in accordance with the first validity rule.

Aspect 35: The method of any of aspects 33 through 34, wherein the valid RO is valid based at least in part on the valid RO and the second RO each mapping to a same synchronization signal block index, in accordance with the first validity rule.

Aspect 36: The method of any of aspects 33 through 35, wherein the valid RO is valid based at least in part on the valid RO being associated with a first frequency span and the second RO being associated with a second frequency span, and a frequency distance between the first frequency span and the second frequency span satisfies a threshold, in accordance with the first validity rule.

Aspect 37: The method of any of aspects 24 through 36, wherein the random access procedure is a two-step random access procedure, the method further comprising: receiving, during a valid PUSCH occasion of a plurality of PUSCH occasions, a data message, wherein the valid PUSCH occasion is based at least in part on a second validity rule, wherein the second validity rule defines a validity of a PUSCH occasion when the PUSCH occasion is associated with a second slot that spans one or more second SBFD resources and one or more second non-SBFD resources.

Aspect 38: The method of aspect 37, wherein the second validity rule defines the validity of the valid PUSCH occasion based at least in part on the valid PUSCH occasion spanning exclusively the one or more second SBFD resources of the second slot or spanning exclusively the one or more second non-SBFD resources of the second slot.

Aspect 39: The method of any of aspects 37 through 38, wherein the second validity rule defines the validity of the valid PUSCH occasion based at least in part on the valid PUSCH occasion spanning the one or more second SBFD resources and the one or more second non-SBFD resources of the second slot, the one or more second SBFD resources and the one or more second non-SBFD resources are directly adjacent in time, and the PUSCH occasion is associated with a same plurality of frequency resources, a same spatial configuration, and a same power control parameter across the one or more second SBFD resources and the one or more second non-SBFD resources of the second slot.

Aspect 40: The method of any of aspects 37 through 39, wherein the second slot comprises a second guard period between the one or more second SBFD resources and the one or more second non-SBFD resources and the valid PUSCH occasion spans the second guard period, the one or more second SBFD resources and the one or more second non-SBFD resources.

Aspect 41: The method of aspect 40, further comprising: receiving each portion of the data message during the valid PUSCH occasion that spans the second guard period, the one or more second SBFD resources and the one or more second non-SBFD resources, wherein the data message is associated with a same set of transmission parameters across the one or more second SBFD resources and the one or more second non-SBFD resources.

Aspect 42: The method of any of aspects 40 through 41, further comprising: receiving a first portion of the data message associated with the one or more second SBFD resources of the second slot prior to the second guard period.

Aspect 43: The method of aspect 42, further comprising: receiving a second portion of the data message associated with resources during the second guard period.

Aspect 44: The method of any of aspects 40 through 43, further comprising: receiving a first portion of the data message associated with the one or more second non-SBFD resources of the second slot after to the second guard period.

Aspect 45: A UE for wireless communications, comprising one or more memories storing processor-executable code, and one or more processors coupled with the one or more memories and individually or collectively operable to execute the code to cause the UE to perform a method of any of aspects 1 through 23.

Aspect 46: A UE for wireless communications, comprising at least one means for performing a method of any of aspects 1 through 23.

Aspect 47: A non-transitory computer-readable medium storing code for wireless communications, the code comprising instructions executable by one or more processors to perform a method of any of aspects 1 through 23.

Aspect 48: A network entity for wireless communications, comprising one or more memories storing processor-executable code, and one or more processors coupled with the one or more memories and individually or collectively operable to execute the code to cause the network entity to perform a method of any of aspects 24 through 44.

Aspect 49: A network entity for wireless communications, comprising at least one means for performing a method of any of aspects 24 through 44.

Aspect 50: A non-transitory computer-readable medium storing code for wireless communications, the code comprising instructions executable by one or more processors to perform a method of any of aspects 24 through 44.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates to the UE a plurality of random access channel (RACH) occasions for performance of a random access procedure;
select a valid RACH occasion from the plurality of RACH occasions based at least in part on a first validity rule, wherein the first validity rule defines a validity of a RACH occasion when the RACH occasion is associated with a first slot that spans one or more sub-band full duplex (SBFD) resources and one or more non-SBFD resources; and
transmit, during the valid RACH occasion selected in accordance with the first validity rule, a physical RACH (PRACH) preamble.

2. The UE of claim 1, wherein the valid RACH occasion is valid based at least in part on the valid RACH occasion spanning exclusively the one or more SBFD resources of the first slot or spanning exclusively the one or more non-SBFD resources of the first slot, in accordance with the first validity rule.

3. The UE of claim 1, wherein the RACH occasion is not valid based at least in part on the RACH occasion spanning the one or more SBFD resources and the one or more non-SBFD resources, in accordance with the first validity rule.

4. The UE of claim 1, wherein:
the valid RACH occasion is valid based at least in part on the valid RACH occasion spanning the one or more SBFD resources and the one or more non-SBFD resources;
the one or more SBFD resources and the one or more non-SBFD resources are directly adjacent in time; and
the valid RACH occasion is associated with a same plurality of frequency resources, a same spatial configuration, and a same power control parameter across the one or more SBFD resources and the one or more non-SBFD resources, in accordance with the first validity rule.

5. The UE of claim 1, wherein the first slot comprises a guard period between the one or more SBFD resources and the one or more non-SBFD resources and the valid RACH occasion spans the guard period, the one or more SBFD resources and the one or more non-SBFD resources.

6. The UE of claim 5, wherein the one or more processors are individually or collectively further operable to execute the code to cause the UE to:
transmit each portion of the PRACH preamble during the valid RACH occasion that spans the guard period, the one or more SBFD resources and the one or more non-SBFD resources, wherein the PRACH preamble is associated with a same set of transmission parameters across the one or more SBFD resources and the one or more non-SBFD resources.

7. The UE of claim 1, wherein:
the valid RACH occasion spans the one or more SBFD resources and the one or more non-SBFD resources; and
the UE is configured with a second RACH occasion that exclusively spans the one or more non-SBFD resources, the second RACH occasion comprising a time division duplex RACH occasion.

8. The UE of claim 7, wherein the valid RACH occasion is valid based at least in part on the valid RACH occasion spanning one or more first symbols across the one or more non-SBFD resources that are non-overlapping with one or more second symbols associated with the second RACH occasion, in accordance with the first validity rule.

9. The UE of claim 7, wherein the valid RACH occasion is valid based at least in part on the valid RACH occasion and the second RACH occasion each mapping to a same synchronization signal block index, in accordance with the first validity rule.

10. The UE of claim 7, wherein:
the valid RACH occasion is valid based at least in part on the valid RACH occasion being associated with a first frequency span and the second RACH occasion being associated with a second frequency span; and
a frequency distance between the first frequency span and the second frequency span satisfies a threshold, in accordance with the first validity rule.

11. The UE of claim 1, wherein the random access procedure is a two-step random access procedure, and the one or more processors are individually or collectively further operable to execute the code to cause the UE to:
select a valid physical uplink shared channel (PUSCH) occasion from a plurality of PUSCH occasions based at least in part on a second validity rule, wherein the second validity rule defines a validity of a PUSCH occasion when the PUSCH occasion is associated with a second slot that spans one or more second SBFD resources and one or more second non-SBFD resources; and
transmit, during the valid PUSCH occasion selected in accordance with the second validity rule, a data message.

12. The UE of claim 1, wherein the PRACH occasion is not valid based at least in part on the PRACH occasion spanning the one or more SBFD resources and the one or more non-SBFD resources, in accordance with the first validity rule.

13. The UE of claim 11, wherein the second validity rule defines the validity of the valid PUSCH occasion based at least in part on the valid PUSCH occasion spanning exclusively the one or more second SBFD resources of the second slot or spanning exclusively the one or more second non-SBFD resources of the second slot.

14. The UE of claim 11, wherein:
the second validity rule defines the validity of the valid PUSCH occasion based at least in part on the valid PUSCH occasion spanning the one or more second SBFD resources and the one or more second non-SBFD resources of the second slot;
the one or more second SBFD resources and the one or more second non-SBFD resources are directly adjacent in time; and
the PUSCH occasion is associated with a same plurality of frequency resources, a same spatial configuration, and a same power control parameter across the one or more second SBFD resources and the one or more second non-SBFD resources of the second slot.

15. The UE of claim 11, wherein the second slot comprises a second guard period between the one or more second SBFD resources and the one or more second non-SBFD resources and the valid PUSCH occasion spans the second guard period, the one or more second SBFD resources and the one or more second non-SBFD resources.

16. The UE of claim 15, wherein the one or more processors are individually or collectively further operable to execute the code to cause the UE to:
transmit each portion of the data message during the valid PUSCH occasion that spans the second guard period, the one or more second SBFD resources and the one or more second non-SBFD resources, wherein the data message is associated with a same set of transmission parameters across the one or more second SBFD resources and the one or more second non-SBFD resources.

17. A method for wireless communications, at a user equipment (UE), comprising:
receiving a configuration information that indicates to the UE a plurality of random access channel (RACH) occasions for performance of a random access procedure;
selecting a valid RACH occasion from the plurality of RACH occasions based at least in part on a first validity rule, wherein the first validity rule defines a validity of a RACH occasion when the RACH occasion is associated with a first slot that spans one or more sub-band full duplex (SBFD) resources and one or more non-SBFD resources; and
transmitting, during the valid RACH occasion selected in accordance with the first validity rule, a physical RACH (PRACH) preamble.

18. The UE of claim 17, wherein the valid RACH occasion is valid based at least in part on the valid RACH occasion spanning exclusively the one or more SBFD resources of the first slot or spanning exclusively the one or more non-SBFD resources of the first slot, in accordance with the first validity rule.

19. The UE of claim 17, wherein:
the valid RACH occasion is valid based at least in part on the valid RACH occasion spanning the one or more SBFD resources and the one or more non-SBFD resources;
the one or more SBFD resources and the one or more non-SBFD resources are directly adjacent in time; and
the valid RACH occasion is associated with a same plurality of frequency resources, a same spatial configuration, and a same power control parameter across the one or more SBFD resources and the one or more non-SBFD resources, in accordance with the first validity rule.

20. A non-transitory computer-readable medium storing code for wireless communication, the code comprising instructions executable by one or more processors to:
receive a configuration information that indicates a plurality of random access channel (RACH) occasions for performance of a random access procedure;
select a valid RACH occasion from the plurality of RACH occasions based at least in part on a first validity rule, wherein the first validity rule defines a validity of a RACH occasion when the RACH occasion is associated with a first slot that spans one or more sub-band full duplex (SBFD) resources and one or more non-SBFD resources; and
transmit, during the valid RACH occasion selected in accordance with the first validity rule, a physical RACH (PRACH) preamble.
